(19) United States
(12) Patent Application Publication
(10) Pub. No.: US 2023/0294988 A1
(43) Pub. Date: Sep. 21, 2023

(54) CATALYST FOR HYDROGEN CHLORIDE OXIDATION AND PRODUCTION THEREOF

(71) Applicant: BASF SE, Ludwigshafen am Rhein (DE)

(72) Inventors: Alvaro GORDILLO BOLONIO, Barcelona (ES); Claudia LERMER, Ludwigshafen am Rhein (DE); Andrei-Nicolae PARVULESCU, Ludwigshafen am Rhein (DE); Bilge YILMAZ, Iselin, NJ (US); David SCHLERETH, Ludwigshafen am Rhein (DE); Hendrik DE WINNE, Antwerp (BE); Elena PARVULESCU, Ludwigshafen am Rhein (DE); Joseph John ZAKZESKI, Ludwigshafen am Rhein (DE); Ulrich MUELLER, Neustadt (DE)

(21) Appl. No.: 17/927,759

(22) PCT Filed: May 28, 2021
(86) PCT No.: PCT/EP2021/064344

§ 371 Date: Nov. 25, 2022

(30) Foreign Application Priority Data
May 29, 2020 (EP) 20177294

(51) Int. Cl. C01B 7/04; B01J 35/10; B01J 37/30; B01J 37/08; B01J 23/83

(52) U.S. Cl. CPC C01B 7/04; B01J 23/83; B01J 35/1014; B01J 35/1019; B01J 35/1023; B01J 35/1038; B01J 37/088; B01J 37/30

(57) ABSTRACT

The present invention relates to a catalyst for the oxidation of hydrogen chloride to chlorine, wherein the catalyst comprises an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the inorganic carrier matrix and the zeolite are loaded with copper and with one or more rare earth metals, and wherein the zeolite is supported within the inorganic carrier matrix. Furthermore, the present invention relates to a molding comprising the catalyst, as well as to a process for the production of the catalyst and the molding, respectively, as well as to their respective use in a process for the oxidation of hydrogen chloride to chlorine.

### TECHNICAL FIELD

The present invention relates to a catalyst for the oxidation of hydrogen chloride to chlorine, wherein the catalyst comprises an inorganic carrier matrix and a zeolite, which are particularly loaded with copper and with one or more rare earth metals. Further, the present invention relates to a molding comprising the catalyst according to any one of the embodiments disclosed herein. Yet further, the present invention relates to a process for production of said catalyst as well as a process for production of said molding and to a process for the oxidation of hydrogen chloride to chlorine.

### INTRODUCTION

In industrial chemistry, methlyenediphenylisocyanate (MDI) and toluenediisocyanate (TDI) are typically produced using phosgene. Thus, during the process of conversion of a diamine to the respective isocyanates considerable amounts of hydrogen chloride are formed as a by-product. Therefore, it is of high interest to include the formed hydrogen chloride in the entire value-added chain. In particular, hydrogen chloride can be oxidized in a catalytic oxidation with oxygen, for example according to the Deacon reaction, also referred to as “HCl oxidation”. In a recent approach, fluidized bed Deacon technology with Cu catalysts is applied in this regard. It is suggested that a zeolite type carrier comprising Y-zeolite, kaolin and/or other aluminosilicates shows comparatively improved characteristics than other known Al₂O₃ carriers, especially with respect to minimizing the erosion rate. Several fluid catalytic catalysts are known.

US 4,493,902 A, US 5,023,220 A, US 5,395,809 A, US 5,559,067 A, and WO 2004/103558 A1 respectively relate to a fluid catalytic cracking catalyst being provided with a high porosity. In WO 2004/103558 A1 it is disclosed that the catalyst can be prepared by in-situ crystallizing an aluminosilicate zeolite from a reactive microsphere comprising metakaolin and hydrous kaolin. US 4,493,902 A relates to a fluid catalytic cracking catalyst comprising microspheres containing at least about 40% by weight Y-faujasite and having less than about 0.20 cc/g of pores having diameters in the range of 20-100 Angstrom. The microspheres may contain a non-zeolitic component comprising metakaolin and kaolin clay.

WO 2017/218879 A1 discloses in claim 1 a zeolite fluid catalytic cracking catalyst comprising Y-faujasite crystallized in-situ from a metakaolin-containing calcined microsphere, and an aluminacontaining matrix obtained by calcination of a dispersible crystalline boehmite and a kaolin contained in the metakaolin-containing calcined microsphere, wherein the dispersible crystalline boehmite has a crystallite size of less than 500 A.

WO 95/12454 A1 discloses a zeolitic fluid catalytic cracking catalyst having reduced coke yield which is obtained by a process in particular comprising preparation of a mixture comprising kaolin clay and a binder, spray-drying of said mixture to obtain microspheres, calcining thereof, and crystallizing Y-faujasite in the microspheres.

EP 2418016 A1 relates to a chlorine production catalyst particularly characterized in that it comprises spherical particles containing copper, an alkali metal and a lanthanoid, wherein the spherical particles have an average sphericity of not less than 0.80.

JP 2010248062 A relates to a process for producing chlorine from hydrogen chloride using a catalyst being in particulate form and comprising copper. It is disclosed that the catalyst particles can have an average particle diameter of 70 to 300 micrometer and that the catalyst can comprise copper, a rare earth element and an alkali element.

WO 2011/118386 A1 discloses a method for producing chlorine from hydrogen chloride by oxidizing hydrogen chloride in a fluidized bed reactor containing a catalyst layer, wherein the catalyst used in the catalyst layer can comprise spherical particles containing copper.

EP 3549907 A1 also relates to a method for producing chlorine by oxidation of hydrogen chloride with oxygen in the presence of a catalyst. The catalyst can contain copper, an alkali metal and a rare earth metal.

EP 2481478 A1 discloses a catalyst for producing chlorine by oxidation of hydrogen chloride comprising a support and active ingredients, wherein the active ingredients comprise 1-20 wt% of copper, 0.01-5 wt% of boron, 0.1-10 wt% of alkali metal element(s), 0.1-15 wt% of one or more rare earth elements, and 0-10 wt% of one or more elements selected from magnesium, calcium, barium, manganese, iron, nickel, cobalt, zinc, ruthenium and titanium, based on the total weight of the catalyst.

CN 108097232 A discloses a catalyst for producing chlorine, characterized by comprising a catalyst precursor A, a catalyst precursor B and an inorganic membrane, the inorganic membrane covering the catalyst precursor A thereby separating the catalyst precursor B and the catalyst precursor A, wherein the catalyst precursor A includes a carrier and a copper element, an alkali metal element, and a rare earth element supported on the carrier, and wherein the catalyst precursor B includes a carrier and an alkali metal element and a rare earth element supported on the carrier, whereby the catalyst precursor B does not include a copper element.

EP 3450014 A1 discloses a catalyst for preparing chlorine gas by hydrogen chloride oxidation, wherein the catalyst comprises a copper element, a manganese element, a boron element, a chromium element, a rare earth element, a potassium element, a titanium element, a phosphorus element, an iron element and a carrier.

EP 3097976 A1 relates to a method for preparing a catalyst suitable for preparing chlorine by oxidizing hydrogen chloride. The method particularly comprises treating a slurry with spray-drying to obtain catalyst precursor particles comprising copper, boron, alkali metal elements, rare earth metal elements, aluminum sol, silica sol, a carrier, and optionally at least one of Mg, Ca, Ba, Mn, Ru, and Ti.

CN 106517095 discloses a process for the preparation of chlorine gas is carried out in a fixed bed tube reactor. As a catalyst a composite metal oxychloride is disclosed having a chemical formula CuₐV_{b}R_{c}D_{d}CₑCl_{f}O_{g}, wherein R is one or more of Ce, La, or Pr, D is Na or K, C is Si, Al or Ti, and wherein 2 < a ≤ 10, b = 1, 0 < c ≤ 6, 0 < d ≤ 5, 20 < e ≤ 40, and wherein f, g depend on the degree of oxychlorination of each element.

### DETAILED DESCRIPTION

Thus, it was an object of the present invention to provide an improved catalyst having advantageous properties, in particular for the catalytic oxidation of hydrogen chloride, more particularly for the application in the Deacon process. In particular, it was an object to provide an improved catalyst which shows a very good longevity and shows an improved catalytic performance, in particular with regard to the conversion of hydrogen chloride to chlorine. Further, it was an object to provide an improved molding comprising a catalyst suitable for converting hydrogen chloride to chlorine. Thus, it was an object to provide an improved process for the conversion of hydrogen chloride to chlorine. In addition to that, it was an object to provide a process for production of said catalyst and said molding.

It was surprisingly found that a novel catalyst can be provided particularly characterized in that it comprises an inorganic carrier matrix and a zeolite, wherein the inorganic carrier matrix and the zeolite are loaded with copper and with one or more rare earth metals, and wherein the zeolite is supported within the inorganic carrier matrix. Said catalyst exhibits the above mentioned advantageous characteristics. Furthermore, it has surprisingly been found that a molding comprising a catalyst can be provided which shows, if used as a catalyst in a conversion of hydrogen chloride to chlorine and if compared to a prior art molding comprising a different catalyst, a significantly increased conversion of hydrogen chloride, and further exhibits excellent life time properties.

Therefore, the present invention relates to a catalyst for the oxidation of hydrogen chloride to chlorine, wherein the catalyst comprises an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the inorganic carrier matrix and the zeolite are loaded with copper and with one or more rare earth metals, and wherein the zeolite is supported within the inorganic carrier matrix.

With respect to the inorganic carrier matrix of said catalyst, it is preferred that the inorganic carrier matrix is in the form of microsphere particles having a weight average particle diameter D50 comprised in the range of from 20 to 250 µm, more preferably of from 30 to 200 µm, more preferably of from 40 to 150 µm, more preferably of from 50 to 120 µm, more preferably of from 60 to 100 µm, more preferably of from 70 to 90 µm, and more preferably of from 75 to 85 µm, wherein the weight average particle diameter D50 is preferably determined according to ISO 13317-3:2001 and preferably calculated according to ISO 9276-2:2014.

Further with respect to the inorganic carrier matrix of said catalyst, it is preferred that the inorganic carrier matrix displays an Hg-porosity in the range of from 0.1 to 2.5 mL/g, more preferably from 0.3 to 1.5 mL/g, more preferably from 0.4 to 1 mL/g, more preferably from 0.5 to 0.75 mL/g, more preferably from 0.55 to 0.65 mL/g, and more preferably from 0.6 to 0.62 mL/g, wherein the Hg-porosity is preferably determined according to ISO 15901-1:2016.

Further with respect to the inorganic carrier matrix of said catalyst, it is preferred that the inorganic carrier matrix displays a BET surface area in the range of from 300 to 600 m²/g, preferably from 350 to 550 m²/g, more preferably from 375 to 500 m²/g, more preferably from 400 to 475 m²/g, more preferably from 425 to 450 m²/g, and more preferably from 440 to 445 m²/g, wherein the BET surface area is preferably determined according to ISO 9277:2010.

Further with respect to the inorganic carrier matrix of said catalyst, it is preferred that the ammonia temperature programmed desorption of the inorganic carrier matrix displays:
a first peak in the range of from 150 to 270° C., more preferably of from 170 to 250° C., more preferably of from 190 to 220° C., and more preferably of from 200 to 205° C.;
a second peak in the range of from 270 to 375° C., more preferably of from 290 to 355° C., more preferably of from 310 to 335° C., and more preferably of from 320 to 325° C.; and
more preferably comprising a third peak in the range of from 535 to 640° C., preferably of from 555 to 620° C., more preferably of from 575 to 600° C., and more preferably of from 585 to 590° C.;
   wherein the integration of the first peak offers a concentration of acid sites in the range of from 0.3 to 1.5 mmol/g, more preferably of from 0.5 to 1.3 mmol/g, more preferably of from 0.75 to 1.05 mmol/g, more preferably of from 0.85 to 0.95 mmol/g, and more preferably of from 0.88 to 0.9 mmol/g;
   wherein the integration of the second peak offers a concentration of acid sites in the range of from 0.3 to 1.5 mmol/g, more preferably of from 0.5 to 1.3 mmol/g, more preferably of from 0.7 to 1 mmol/g, more preferably of from 0.8 to 0.9 mmol/g, and more preferably of from 0.83 to 0.85 mmol/g; and
   wherein the integration of the preferred third peak offers a concentration of acid sites in the range of from 0.01 to 0.1 mmol/g, more preferably of from 0.02 to 0.07 mmol/g, and more preferably of from 0.03 to 0.05 mmol/g.

With respect to said catalyst, it is preferred that Y is selected from the group consisting of Si, Sn, Ti, Zr, Ge, and a mixture of two or more thereof, more preferably from the group consisting of Si, Ti, Ge, and a mixture of two or more thereof, more preferably from the group consisting of Si, Ti, and a mixture thereof, wherein Y is more preferably Si.

With respect to said catalyst, it is preferred that X is selected from the group consisting of B, Al, Ga, In, and a mixture of two or more thereof, more preferably from the group consisting of B, Al, Ga, and a mixture of two or more thereof, more preferably from the group consisting of Al, Ga, and a mixture of two or more thereof, wherein X more preferably is Al.

It is preferred that the catalyst comprises Y in an amount ranging from 15 to 45 wt.-%, more preferably in the range of from 22 to 35 wt.-%, more preferably in the range of from 26 to 31 wt.-%, more preferably in the range of from 28 to 29 wt.-%, calculated as the element and based on 100 wt.-% of the total amount of Y and X, calculated as the respective oxides YO₂ and X₂O₃, contained in the catalyst.

It is preferred that the catalyst comprises X in an amount ranging from 10 to 30 wt.-%, more preferably in the range of from 16 to 25 wt.-%, more preferably in the range of from 18 to 23 wt.-%, more preferably in the range of from 20 to 21 wt.-%, calculated as the element and based on 100 wt.-% of the total amount of Y and X, calculated as the respective oxides YO₂ and X₂O₃, contained in the catalyst.

It is preferred that the catalyst displays a molar ratio Y comprised in the inorganic carrier matrix and the zeolite to X comprised in the inorganic carrier matrix and the zeolite, calculated as YO₂ : X₂O₃, in the range of from 0.5:1 to 10:1, more preferably in the range of from 1:1 to 6:1, more preferably in the range of from 2.0:1 to 3.5:1, more preferably in the range of from 2.5:1 to 2.9:1, more preferably in the range of from 2.6:1 to 2.8:1.

It is preferred that the copper loading of the inorganic carrier matrix and the zeolite is in the range of from 2 to 10 wt.-%, more preferably in the range of from 5.0 to 9.0 wt.-%, more preferably in the range of from 6.5 to 7.5 wt.-%, more preferably in the range of from 7.0 to 7.2 wt.-%, calculated as the element and based on 100 wt.-% of the total amount of Y and X, calculated as the respective oxides YO₂ and X₂O₃, contained in the inorganic carrier matrix and the zeolite.

It is preferred that the catalyst displays a molar ratio of Y comprised in the inorganic carrier matrix and the zeolite to copper loaded on the inorganic carrier matrix and the zeolite, in the range of from 3 to 15, more preferably in the range of from 7 to 11, more preferably in the range of from 9.0:1 to 9.3:1, more preferably in the range of from 9.1:1 to 9.2:1.

It is preferred that the one or more rare earth metals are selected from the group consisting of Sc, Y, La, Ce, Pr, Nd, Sm, Eu, Gd, Tb, Dy, Ho, Er, Tm, Yb, Lu, and a mixture of two or more thereof, more preferably from the group consisting of La, Ce, Pr, Nd, Sm, Ho, Lu, and a mixture of two or more thereof, more preferably from the group consisting of Ce, Sm, La, and a mixture of two or more thereof, wherein the inorganic carrier matrix and the zeolite more preferably are loaded with Ce, more preferably with Ce and La, and more preferably with Ce, Sm, and La.

It is preferred that the rare earth metal loading of the inorganic carrier matrix and the zeolite is in the range of from 5 to 50 wt.-%, preferably in the range of from 8 to 30 wt.-%, more preferably in the range of from 10 to 15 wt.-%, more preferably in the range of from 12 to 13 wt.-%, calculated as the sum of the one or more rare earth metals as elements and based on 100 wt.-% of the total amount of Y and X, calculated as the respective oxides YO₂ and X₂O₃, contained in the inorganic carrier matrix and the zeolite.

It is preferred that the inorganic carrier matrix and the zeolite are loaded with Ce.

In the case where the inorganic carrier matrix and the zeolite are loaded with Ce, it is preferred that the Ce loading of the inorganic carrier matrix and the zeolite is in the range of from 1 to 6 wt.-%, more preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

Further in the case where the inorganic carrier matrix and the zeolite are loaded with Ce, it is preferred that the catalyst displays a molar ratio of Y comprised in the inorganic carrier matrix and in the zeolite to Ce loaded on the inorganic carrier matrix and the zeolite, Y:Ce, in the range of from 25:1 to 75:1, preferably in the range of from 32:1 to 50:1, more preferably in the range of from 38:1 to 43:1, more preferably in the range of from 40:1 to 41:1.

It is preferred that the inorganic carrier matrix and the zeolite are loaded with Sm.

In the case where the inorganic carrier matrix and the zeolite are loaded with Sm, it is preferred that the Sm loading of the inorganic carrier matrix and the zeolite is in the range of from 1 to 6 wt.-%, more preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

Further in the case where the inorganic carrier matrix and the zeolite are loaded with Sm, it is preferred that the catalyst displays a molar ratio of Y comprised in the inorganic carrier matrix and in the zeolite to Sm loaded on the inorganic carrier matrix and the zeolite, Y:Sm, in the range of from 25:1 to 75:1, more preferably in the range of from 35:1 to 52:1, more preferably in the range of from 41:1 to 46:1, more preferably in the range of from 43:1 to 44:1.

It is preferred that the inorganic carrier matrix and the zeolite are loaded with La.

In the case where the inorganic carrier matrix and the zeolite are loaded with La, it is preferred that the La loading of the inorganic carrier matrix and the zeolite is in the range of from 2 to 8.5 wt.-%, more preferably in the range of from 4.0 to 6.5 wt.-%, more preferably in the range of from 5.0 to 5.6 wt.-%, more preferably in the range of from 5.2 to 5.4 wt.-%, calculated as the element and based on 100 wt.-% of the total amount of Y and X, calculated as the respective oxides YO₂ and X₂O₃, contained in the inorganic carrier matrix and the zeolite.

Further in the case where the inorganic carrier matrix and the zeolite are loaded with La, it is preferred that the catalyst displays a molar ratio of Y comprised in the inorganic carrier matrix and in the zeolite to La loaded on the inorganic carrier matrix and the zeolite, Y:La, in the range of from 10:1 to 50:1, preferably in the range of from 20:1 to 33:1, more preferably in the range of from 24:1 to 29:1, more preferably in the range of from 26:1 to 27:1.

It is preferred that the inorganic carrier matrix and the zeolite are further loaded with one or more alkali metals, wherein the one or more alkali metals are preferably selected from the group consisting of Li, Na, K, Rb, Cs, and a mixture of two or more thereof, preferably from the group consisting of Na, K, and a mixture thereof, wherein the one or more alkali metals more preferably are K.

In the case where the inorganic carrier matrix and the zeolite are further loaded with one or more alkali metals, it is preferred that the alkali metal loading of the inorganic carrier matrix and the zeolite is in the range of from 1 to 7.5 wt.-%, more preferably in the range of from 3.0 to 5.5 wt.-%, more preferably in the range of from 4.0 to 4.6 wt.-%, more preferably in the range of from 4.2 to 4.4 wt.-%, calculated as the sum of the one or more alkali metals as elements and based on 100 wt.-% of the total amount of Y and X, calculated as the respective oxides YO₂ and X₂O₃, contained in the inorganic carrier matrix and the zeolite.

Further in the case where the inorganic carrier matrix and the zeolite are further loaded with one or more alkali metals, it is preferred that the catalyst displays a molar ratio of Y comprised in the inorganic carrier matrix and in the zeolite to the one or more alkali metals loaded on the inorganic carrier matrix and the zeolite in the range of from 1:1 to 20:1, preferably in the range of from 5:1 to 15:1, more preferably in the range of from 8:1 to 11:1, more preferably in the range of from 9:1 to 10:1.

It is preferred that the inorganic carrier matrix comprises one or more inorganic oxides selected from the group consisting of silica, alumina, titania, zirconia, magnesia, clays, and a mixture of two or more thereof, preferably from the group consisting of a montmorillonite, a kaolin, a metakaolin, a bentonite, a halloysite, a dickite, a nacrite, an anauxite, and a mixture of two or more thereof, more preferably from the group consisting of a kaolin, a metakaolin, and a mixture thereof.

It is preferred that the catalyst displays a BET surface area in the range of from 100 to 600 m²/g, more preferably in the range of from 250 to 450 m²/g, more preferably in the range of from 310 to 380 m²/g, more preferably in the range of from 330 to 360 m²/g, more preferably in the range of from 340 to 350 m²/g, wherein the BET surface area is preferably determined according to ISO 9277:2010.

It is preferred that the zeolite has a framework structure type selected from the group consisting of FAU, GIS, MOR, LTA, FER, TON, MTT, BEA, MEL, MWW, MFS, MFI, and a mixed type of two or more thereof, more preferably from the group consisting of FAU, GIS, BEA, MFI, and mixed type of two or more thereof, wherein the zeolite more preferably has an FAU and/or BEA framework structure type, and more preferably an FAU framework structure type.

It is preferred that the zeolite has an FAU framework structure type, wherein the zeolite preferably is selected from the group consisting of ZSM-3, Faujasite, [AI-Ge-O]-FAU, CSZ-1, ECR-30, Zeolite X, Zeolite Y, LZ-210, SAPO-37, ZSM-20, Na-X, US-Y, Na-Y, [Ga-Ge-O]-FAU, Li-LSX, [Ga-Al-Si-O]-FAU, [Ga-Si-O]-FAU, and a mixture of two or more thereof, more preferably from the group consisting of ZSM-3, Faujasite, CSZ-1, ECR-30, Zeolite X, Zeolite Y, LZ-210, ZSM-20, Na-X, US-Y, Na-Y, Li-LSX, and a mixture of two or more thereof, more preferably from the group consisting of Faujasite, Zeolite X, Zeolite Y, Na-X, US-Y, Na-Y, and a mixture of two or more thereof, more preferably from the group consisting of Faujasite, Zeolite X, Zeolite Y, and a mixture of two or more thereof, wherein more preferably the zeolite having an FAU framework structure type comprises Zeolite X and/or Zeolite Y, preferably Zeolite Y, wherein more preferably the zeolite having an FAU framework structure type is Zeolite X and/or Zeolite Y, preferably Zeolite Y.

It is preferred that the catalyst comprises the zeolite in an amount in the range of from 10 to 90 wt.-%, more preferably in the range of from 20 to 80 wt.-%, more preferably in the range of from 30 to 70 wt.-%, more preferably in the range of from 40 to 60 wt.-%, and more preferably in the range of from 45 to 55 wt.-%, based on 100 wt.-% of the total amount of Y and X, calculated as the respective oxides YO₂ and X₂O₃, contained in the catalyst.

It is preferred that the catalyst comprises the inorganic carrier matrix in an amount in the range of from 10 to 90 wt.-%, more preferably in the range of from 20 to 80 wt.-%, more preferably in the range of from 30 to 70 wt.-%, more preferably in the range of from 40 to 60 wt.-%, and more preferably in the range of from 45 to 55 wt.-%, based on 100 wt.-% of the total amount of Y and X, calculated as the respective oxides YO₂ and X₂O₃, contained in the catalyst.

It is preferred that the catalyst comprises from 0 to 1 wt.-%, more preferably from 0 to 0.1 wt.-%, more preferably from 0 to 0.01 wt.-%, more preferably from 0 to 0.001 wt.-% of Cl, calculated as the element, based on 100 wt.-% of the catalyst.

Further, the present invention relates to a molding comprising the catalyst according to any one of the embodiments disclosed herein.

It is preferred that the molding displays a BET surface area which is comprised in the range of from 50 to 600 m²/g, more preferably in the range of from 150 to 450 m²/g, more preferably in the range of from 220 to 360 m²/g, more preferably in the range of from 270 to 310 m²/g, more preferably in the range of from 280 to 300 m²/g, wherein the BET surface area is preferably determined according to ISO 9277:2010.

It is preferred that the molding displays a total pore volume comprised in the range of from 0.2 to 0.4 cm³/g, more preferably in the range of from 0.26 to 0.33 cm³/g, more preferably in the range of from 0.29 to 0.30 cm³/g, wherein the total pore volume is preferably determined according to ISO 15901-2:2006.

It is preferred that the molding displays a micropore volume comprised in the range of from 0.01 to 0.20 cm³/g, more preferably in the range of from 0.05 to 0.15 cm³/g, more preferably in the range of from 0.09 to 0.11 cm³/g, wherein the micropore volume is preferably determined according to ISO 15901-3:2007.

It is preferred that the molding displays an adsorption average pore width (4V/A) comprised in the range of from 1 to 8 nm, more preferably in the range of from 3.5 to 5.0 nm, more preferably in the range of from 4.0 to 4.2 nm, wherein the adsorption average pore width (4V/A) is preferably determined according to ISO 15901-2:2006.

It is preferred that the molding displays a desorption average pore diameter (4V/A) comprised in the range of from 5 to 15 nm, more preferably in the range of from 9.0 to 11.0 nm, more preferably in the range of from 9.7 to 9.9 nm, wherein the desorption average pore diameter (4V/A) is preferably determined according to DIN 66134:1998-02.

It is preferred that the copper loading of the molding is in the range of from 2 to 10 wt.-%, more preferably in the range of from 5.0 to 6.5 wt.-%, more preferably in the range of from 5.5 to 5.9 wt.-%, more preferably in the range of from 5.6 to 5.8 wt.-%, calculated as the element and based on 100 wt.-% of the total amount of Y and X, calculated as the respective oxides YO₂ and X₂O₃, contained in the molding.

It is preferred that the molding displays a molar ratio of Y contained in the molding to copper contained in the molding, in the range of from 10 to 20, more preferably in the range of from 12 to 15, more preferably in the range of from 13.3:1 to 13.9:1, more preferably in the range of from 13.5:1 to 13.7:1.

It is preferred that the rare earth metal loading of the molding is in the range of from 5 to 15 wt.-% wt.-%, more preferably in the range of from 9.0 to 10.5 wt.-%, more preferably in the range of from 9.4 to 9.8 wt.-%, more preferably in the range of from 9.5 to 9.7 wt.-%, calculated as the element(s) and based on 100 wt.-% of the total amount of Y and X, calculated as the respective oxides YO₂ and X₂O₃, contained in the molding.

It is preferred that the inorganic carrier matrix and the zeolite are loaded with Ce, wherein the Ce loading of the molding is more preferably in the range of from 1 to 5 wt.-% wt.-%, more preferably in the range of from 2.0 to 3.5 wt.-%, more preferably in the range of from 2.5 to 2.9 wt.-%, more preferably in the range of from 2.6 to 2.8 wt.-%, calculated as the element and based on 100 wt.-% of the total amount of Y and X, calculated as the respective oxides YO₂ and X₂O₃, contained in the molding.

In the case where the inorganic carrier matrix and the zeolite are loaded with Ce, it is preferred that the molding displays a molar ratio of Y comprised in the inorganic carrier matrix and in the zeolite to Ce loaded on the inorganic carrier matrix and the zeolite, Y:Ce, in the range of from 25:1 to 100:1, more preferably in the range of from 55:1 to 70:1, more preferably in the range of from 60:1 to 66:1, more preferably in the range of from 62:1 to 64:1.

It is preferred that the inorganic carrier matrix and the zeolite are loaded with Sm, wherein the Sm loading of the molding is more preferably in the range of from 1 to 5 wt.-%, more preferably in the range of from 2.0 to 3.5 wt.-%, more preferably in the range of from 2.5 to 2.9 wt.-%, more preferably in the range of from 2.6 to 2.8 wt.-%, calculated as the element and based on 100 wt.-% of the total amount of Y and X, calculated as the respective oxides YO₂ and X₂O₃, contained in the molding.

In the case where the inorganic carrier matrix and the zeolite are loaded with Sm, it is preferred that the molding displays a molar ratio of Y comprised in the inorganic carrier matrix and in the zeolite to Sm loaded on the inorganic carrier matrix and the zeolite, Y:Sm, in the range of from 30:1 to 120:1, more preferably in the range of from 60:1 to 90:1, more preferably in the range of from 65:1 to 70:1, more preferably in the range of from 66.5:1 to 68.5:1.

It is preferred that the inorganic carrier matrix and the zeolite are loaded with La, wherein the La loading of the molding is more preferably in the range of from 2 to 8 wt.-% wt.-%, more preferably in the range of from 3.5 to 5.0 wt.-%, more preferably in the range of from 4.0 to 4.4 wt.-%, more preferably in the range of from 4.1 to 4.3 wt.-%, calculated as the element and based on 100 wt.-% of the total amount of Y and X, calculated as the respective oxides YO₂ and X₂O₃, contained in the molding.

In the case where the inorganic carrier matrix and the zeolite are loaded with La, it is preferred that the molding displays a molar ratio of Y comprised in the inorganic carrier matrix and in the zeolite to La loaded on the inorganic carrier matrix and the zeolite, Y:La, in the range of from 25:1 to 75:1, more preferably in the range of from 33:1 to 47:1, more preferably in the range of from 38:1 to 42:1, more preferably in the range of from 39:1 to 41:1.

It is preferred that the inorganic carrier matrix and the zeolite are further loaded with K, wherein the K loading of the molding is more preferably in the range of from 1 to 7 wt.-% wt.-%, more preferably in the range of from 3.0 to 4.5 wt.-%, more preferably in the range of from 3.5 to 3.9 wt.-%, more preferably in the range of from 3.6 to 3.8 wt.-%, calculated as the element and based on 100 wt.-% of the total amount of Y and X, calculated as the respective oxides YO₂ and X₂O₃, contained in the molding.

In the case where the inorganic carrier matrix and the zeolite are further loaded with K, it is preferred that the molding displays a molar ratio of Y comprised in the inorganic carrier matrix and in the zeolite to K loaded on the inorganic carrier matrix and the zeolite, Y:K, in the range of from 1:1 to 30:1, more preferably in the range of from 7:1 to 20:1, more preferably in the range of from 10:1 to 16:1, more preferably in the range of from 12:1 to 14:1.

It is preferred that the molding comprises Y in an amount ranging from 10 to 60 wt.-%, more preferably in the range of from 25 to 45 wt.-%, more preferably in the range of from 32 to 36 wt.-%, more preferably in the range of from 33 to 35 wt.-%, calculated as the element and based on 100 wt.-% of the total amount of Y and X, calculated as the respective oxides YO₂ and X₂O₃, contained in the molding.

It is preferred that the molding comprises X in an amount ranging from 5 to 25 wt.-%, more preferably in the range of from 10 to 18 wt.-%, more preferably in the range of from 12 to 16 wt.-%, more preferably in the range of from 13 to 15 wt.-%, calculated as the element and based on 100 wt.-% of the total amount of Y and X, calculated as the respective oxides YO₂ and X₂O₃, contained in the molding.

It is preferred that the molding displays a molar ratio of Y contained in the molding to X contained in the molding, calculated as YO₂ : X₂O₃, in the range of from 1:1 to 8:1, more preferably in the range of from 3:1 to 6:1, more preferably in the range of from 4.0:1 to 5.0:1, more preferably in the range of from 4.4:1 to 4.8:1, more preferably in the range of from 4.5:1 to 4.7:1.

It is preferred that the hydrogen temperature programmed reduction of the molding displays:
a first peak in the range of from 175 to 225° C., more preferably of from 185 to 210° C., more preferably of from 190 to 200° C., and more preferably of from 193 to 198° C.; and
a second peak in the range of from 175 to 275° C., more preferably of from 200 to 250° C., more preferably of from 215 to 240° C., and more preferably of from 225 to 230° C.; and
   wherein the integration of the first peak offers a concentration of reducible sites in the range of from 50 to 250 µmol/g, more preferably of from 75 to 225 µmol/g, more preferably of from 100 to 200 µmol/g, more preferably of from 125 to 175 µmol/g, and more preferably of from 150 to 155 µmol/g; and
   wherein the integration of the second peak offers a concentration of reducible sites in the range of from 225 to 600 µmol/g, more preferably of from 250 to 450 µmol/g, more preferably of from 275 to 400 µmol/g, more preferably of from 300 to 350 µmol/g, and more preferably of from 315 to 325 µmol/g.

Yet further the present invention relates to a process for the production of a catalyst, preferably of a catalyst according to any one of the embodiments disclosed herein, for the oxidation of hydrogen chloride to chlorine, the process comprising
(i) providing a carrier comprising an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the zeolite is supported within the inorganic carrier matrix;
(ii) subjecting the carrier to one or more ion-exchange procedures with copper, further with one or more rare earth metals, and preferably further with one or more alkali metals, obtaining a precursor of the catalyst;
(iii) calcining the precursor of the catalyst in a gas atmosphere, obtaining the catalyst.

It is preferred that the inorganic carrier matrix comprised in the carrier according to (i) is in the form of microsphere particles having a weight average particle diameter D50 comprised in the range of from 20 to 250 µm, more preferably of from 30 to 200 µm, more preferably of from 40 to 150 µm, more preferably of from 50 to 120 µm, more preferably of from 60 to 100 µm, more preferably of from 70 to 90 µm, and more preferably of from 75 to 85 µm, wherein the weight average particle diameter D50 is preferably determined according to ISO 13317-3:2001 and preferably calculated according to ISO 9276-2:2014.

It is preferred that the inorganic carrier matrix comprised in the carrier according to (i) displays an Hg-porosity in the range of from 0.1 to 2.5 mL/g, more preferably from 0.3 to 1.5 mL/g, more preferably from 0.4 to 1 mL/g, more preferably from 0.5 to 0.75 mL/g, more preferably from 0.55 to 0.65 mL/g, and more preferably from 0.6 to 0.62 mL/g, wherein the Hg-porosity is preferably determined according to ISO 15901-1:2016.

It is preferred that the inorganic carrier matrix comprised in the carrier according to (i) displays a BET surface area in the range of from 300 to 600 m²/g, more preferably from 350 to 550 m²/g, more preferably from 375 to 500 m²/g, more preferably from 400 to 475 m²/g, more preferably from 425 to 450 m²/g, and more preferably from 440 to 445 m²/g, wherein the BET surface area is preferably determined according to ISO 9277:2010.

It is preferred that the ammonia temperature programmed desorption of the inorganic carrier matrix comprised in the carrier according to (i) displays:
a first peak in the range of from 150 to 270° C., more preferably of from 170 to 250° C., more preferably of from 190 to 220° C., and more preferably of from 200 to 205° C.;
a second peak in the range of from 270 to 375° C., more preferably of from 290 to 355° C., more preferably of from 310 to 335° C., and more preferably of from 320 to 325° C.; and
preferably comprising a third peak in the range of from 535 to 640° C., more preferably of from 555 to 620° C., more preferably of from 575 to 600° C., and more preferably of from 585 to 590° C.;
   wherein the integration of the first peak offers a concentration of acid sites in the range of from 0.3 to 1.5 mmol/g, more preferably of from 0.5 to 1.3 mmol/g, more preferably of from 0.75 to 1.05 mmol/g, more preferably of from 0.85 to 0.95 mmol/g, and more preferably of from 0.88 to 0.9 mmol/g;
   wherein the integration of the second peak offers a concentration of acid sites in the range of from 0.3 to 1.5 mmol/g, more preferably of from 0.5 to 1.3 mmol/g, more preferably of from 0.7 to 1 mmol/g, more preferably of from 0.8 to 0.9 mmol/g, and more preferably of from 0.83 to 0.85 mmol/g; and
   wherein the integration of the preferred third peak offers a concentration of acid sites in the range of from 0.01 to 0.1 mmol/g, more preferably of from 0.02 to 0.07 mmol/g, and more preferably of from 0.03 to 0.05 mmol/g.

It is preferred that Y is selected from the group consisting of Si, Sn, Ti, Zr, Ge, and a mixture of two or more thereof, more preferably from the group consisting of Si, Ti, Ge, and a mixture of two or more thereof, more preferably from the group consisting of Si, Ti, and a mixture thereof, wherein Y is more preferably Si.

It is preferred that X is selected from the group consisting of B, Al, Ga, In, and a mixture of two or more thereof, more preferably from the group consisting of B, Al, Ga, and a mixture of two or more thereof, more preferably from the group consisting of Al, Ga, and a mixture of two or more thereof, wherein X more preferably is Al.

It is preferred that the carrier provided in (i) comprises Y in an amount ranging from 15 to 45 wt.-%, more preferably in the range of from 22 to 35 wt.-%, more preferably in the range of from 26 to 31 wt.-%, more preferably in the range of from 28 to 29 wt.-%, calculated as the element and based on 100 wt.-% of the total amount of Y and X, calculated as the respective oxides YO₂ and X₂O₃, contained in the carrier.

It is preferred that the carrier provided in (i) comprises X in an amount ranging from 10 to 30 wt.-%, more preferably in the range of from 16 to 25 wt.-%, more preferably in the range of from 18 to 23 wt.-%, more preferably in the range of from 20 to 21 wt.-%, calculated as the element and based on 100 wt.-% of the total amount of Y and X, calculated as the respective oxides YO₂ and X₂O₃, contained in the carrier.

It is preferred that the carrier provided in (i) displays a molar ratio Y comprised in the inorganic carrier matrix and the zeolite to X comprised in the inorganic carrier matrix and the zeolite, calculated as YO₂ : X₂O₃, in the range of from 0.5:1 to 10:1, preferably in the range of from 1:1 to 6:1, more preferably in the range of from 2.0:1 to 3.5:1, more preferably in the range of from 2.5:1 to 2.9:1, more preferably in the range of from 2.6:1 to 2.8:1.

It is preferred that in the catalyst obtained in (iii) the copper loading of the inorganic carrier matrix and the zeolite is in the range of from 2 to 10 wt.-%, more preferably in the range of from 5.0 to 9.0 wt.-%, more preferably in the range of from 6.5 to 7.5 wt.-%, more preferably in the range of from 7.0 to 7.2 wt.-%, calculated as the element and based on 100 wt.-% of the total amount of Y and X, calculated as the respective oxides YO₂ and X₂O₃, contained in the inorganic carrier matrix and the zeolite.

It is preferred that the catalyst obtained in (iii) displays a molar ratio of Y comprised in the inorganic carrier matrix and the zeolite to copper loaded on the inorganic carrier matrix and the zeolite, in the range of from 3 to 15, more preferably in the range of from 7 to 11, more preferably in the range of from 9.0:1 to 9.3:1, more preferably in the range of from 9.1:1 to 9.2:1.

It is preferred that the one or more rare earth metals in (ii) are selected from the group consisting of Sc, Y, La, Ce, Pr, Nd, Sm, Eu, Gd, Tb, Dy, Ho, Er, Tm, Yb, Lu, and a mixture of two or more thereof, preferably from the group consisting of La, Ce, Pr, Nd, Sm, Ho, Lu, and a mixture of two or more thereof, more preferably from the group consisting of Ce, Sm, La, and a mixture of two or more thereof, wherein the inorganic carrier matrix and the zeolite more preferably are loaded with Ce, more preferably with Ce and La, and more preferably with Ce, Sm, and La.

It is preferred that in the catalyst obtained in (iii) the rare earth metal loading of the inorganic carrier matrix and the zeolite is in the range of from 5 to 20 wt.-%, more preferably in the range of from 8 to 17 wt.-%, more preferably in the range of from 10 to 15 wt.-%, more preferably in the range of from 12 to 13 wt.-%, calculated as the sum of the one or more rare earth metals as elements and based on 100 wt.-% of the total amount of Y and X, calculated as the respective oxides YO₂ and X₂O₃, contained in the inorganic carrier matrix and the zeolite.

It is preferred that in (ii) the carrier is loaded with Ce.

In the case where the carrier is loaded with Ce in (ii), it is preferred that in the catalyst obtained in (iii) the Ce loading of the carrier is in the range of from 1 to 6 wt.-%, more preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

Further in the case where the carrier is loaded with Ce in (ii), it is preferred that the catalyst obtained in (iii) displays a molar ratio of Y comprised in the inorganic carrier matrix and in the zeolite to Ce loaded on the inorganic carrier matrix and the zeolite, Y:Ce, in the range of from 25:1 to 75:1, more preferably in the range of from 32:1 to 50:1, more preferably in the range of from 38:1 to 43:1, more preferably in the range of from 40:1 to 41:1.

It is preferred that in (ii) the carrier is loaded with Sm.

In the case where in (ii) the carrier is loaded with Sm, it is preferred that in the catalyst obtained in (iii) the Sm loading of the inorganic carrier matrix and the zeolite is in the range of from 1 to 6 wt.-%, more preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

Further in the case where in (ii) the carrier is loaded with Sm, it is preferred that the catalyst obtained in (iii) displays a molar ratio of Y comprised in the inorganic carrier matrix and in the zeolite to Sm loaded on the inorganic carrier matrix and the zeolite, Y:Sm, in the range of from 25:1 to 75:1, more preferably in the range of from 35:1 to 52:1, more preferably in the range of from 41:1 to 46:1, more preferably in the range of from 43:1 to 44:1.

It is preferred that in (ii) the carrier is loaded with La.

In the case where in (ii) the carrier is loaded with La, it is preferred that in the catalyst obtained in (iii) the La loading of the inorganic carrier matrix and the zeolite is in the range of from 2 to 8.5 wt.-%, more preferably in the range of from 4.0 to 6.5 wt.-%, more preferably in the range of from 5.0 to 5.6 wt.-%, more preferably in the range of from 5.2 to 5.4 wt.-%, calculated as the element and based on 100 wt.-% of the total amount of Y and X, calculated as the respective oxides YO₂ and X₂O₃, contained in the inorganic carrier matrix and the zeolite.

Further in the case where in (ii) the carrier is loaded with La, it is preferred that the catalyst obtained in (iii) displays a molar ratio of Y comprised in the inorganic carrier matrix and in the zeolite to La loaded on the inorganic carrier matrix and the zeolite, Y:La, in the range of from 10:1 to 50:1, more preferably in the range of from 20:1 to 33:1, more preferably in the range of from 24:1 to 29:1, more preferably in the range of from 26:1 to 27:1.

It is preferred that in (ii) the carrier is further loaded with one or more alkali metals, wherein the one or more alkali metals are more preferably selected from the group consisting of Li, Na, K, Rb, Cs, and a mixture of two or more thereof, preferably from the group consisting of Na, K, and a mixture thereof, wherein the one or more alkali metals more preferably are K.

In the case where in (ii) the carrier is further loaded with one or more alkali metals, it is preferred that in the catalyst obtained in (iii) the alkali metal loading of the inorganic carrier matrix and the zeolite is in the range of from 1 to 7.5 wt.-%, more preferably in the range of from 3.0 to 5.5 wt.-%, more preferably in the range of from 4.0 to 4.6 wt.-%, more preferably in the range of from 4.2 to 4.4 wt.-%, calculated as the sum of the one or more alkali metals as elements and based on 100 wt.-% of the total amount of Y and X, calculated as the respective oxides YO₂ and X₂O₃, contained in the inorganic carrier matrix and the zeolite.

Further in the case where in (ii) the carrier is further loaded with one or more alkali metals, it is preferred that the catalyst obtained in (iii) displays a molar ratio of Y comprised in the inorganic carrier matrix and in the zeolite to the one or more alkali metals loaded on the inorganic carrier matrix and the zeolite in the range of from 1:1 to 20:1, more preferably in the range of from 5:1 to 15:1, more preferably in the range of from 8:1 to 11:1, more preferably in the range of from 9:1 to 10:1.

It is preferred that the inorganic carrier matrix comprised in the carrier provided in (i) comprises one or more inorganic oxides selected from the group consisting of silica, alumina, titania, zirconia, magnesia, clays, and a mixture of two or more thereof, preferably from the group consisting of a montmorillonite, a kaolin, a metakaolin, a bentonite, a halloysite, a dickite, a nacrite, an anauxite, and a mixture of two or more thereof, more preferably from the group consisting of a kaolin, a metakaolin, and a mixture thereof.

It is preferred that the catalyst obtained in (iii) displays a BET surface area in the range of from 100 to 600 m²/g, more preferably in the range of from 250 to 450 m²/g, more preferably in the range of from 310 to 380 m²/g, more preferably in the range of from 330 to 360 m²/g, more preferably in the range of from 340 to 350 m²/g, wherein the BET surface area is preferably determined according to ISO 9277:2010.

It is preferred that the zeolite comprised in the carrier provided in (i) has a framework structure type selected from the group consisting of FAU, GIS, MOR, LTA, FER, TON, MTT, BEA, MEL, MWW, MFS, MFI, and a mixed type of two or more thereof, preferably from the group consisting of FAU, GIS, BEA, MFI, and mixed type of two or more thereof, wherein the zeolite more preferably has an FAU and/or BEA framework structure type, and more preferably an FAU framework structure type.

It is preferred that the zeolite comprised in the carrier provided in (i) has an FAU framework structure type, wherein the zeolite preferably is selected from the group consisting of ZSM-3, Faujasite, [AI-Ge-O]-FAU, CSZ-1, ECR-30, Zeolite X, Zeolite Y, LZ-210, SAPO-37, ZSM-20, Na-X, US-Y, Na-Y, [Ga-Ge-O]-FAU, Li-LSX, [Ga-Al-Si-O]-FAU, [Ga-Si-O]-FAU, and a mixture of two or more thereof, more preferably from the group consisting of ZSM-3, Faujasite, CSZ-1, ECR-30, Zeolite X, Zeolite Y, LZ-210, ZSM-20, Na-X, US-Y, Na-Y, Li-LSX, and a mixture of two or more thereof, more preferably from the group consisting of Faujasite, Zeolite X, Zeolite Y, Na-X, US-Y, Na-Y, and a mixture of two or more thereof, more preferably from the group consisting of Faujasite, Zeolite X, Zeolite Y, and a mixture of two or more thereof, wherein more preferably the zeolite having an FAU framework structure type comprises Zeolite X and/or Zeolite Y, preferably Zeolite Y, wherein more preferably the zeolite having an FAU framework structure type is Zeolite X and/or Zeolite Y, preferably Zeolite Y.

It is preferred that the carrier provided in (i) comprises the zeolite in an amount in the range of from 68 to 90 wt.-%, more preferably in the range of from 74 to 84 wt.-%, more preferably in the range of from 77 to 81 wt.-%, based on 100 wt.-% of the total amount of Y and X, calculated as the respective oxides YO₂ and X₂O₃, contained in the catalyst.

It is preferred that the carrier provided in (i) comprises the inorganic carrier matrix in an amount in the range of from 10 to 32 wt.-%, more preferably in the range of from 16 to 26 wt.-%, more preferably in the range of from 19 to 23 wt.-%, based on 100 wt.-% of the total amount of Y and X, calculated as the respective oxides YO₂ and X₂O₃, contained in the catalyst.

It is preferred that the catalyst obtained in (iii) comprises from 0 to 1 wt.-%, more preferably from 0 to 0.1 wt.-%, more preferably from 0 to 0.01 wt.-%, more preferably from 0 to 0.001 wt.-% of Cl, calculated as the element, based on 100 wt.-% of the catalyst.

It is preferred that the one or more ion-exchange procedures are performed at a temperature in the range of from 25 to 110° C., more preferably in the range of from 50 to 90° C., more preferably in the range of from 70 to 85° C.

It is preferred that subjecting the carrier to ion-exchange comprises drying of the precursor of the catalyst in a gas atmosphere having a temperature in the range of from 70 to 150° C., preferably in the range of from 90 to 130° C., more preferably in the range of from 100 to 120° C.

It is preferred that the gas atmosphere for drying of the precursor of the catalyst comprises nitrogen, oxygen, or a mixture thereof, wherein the gas atmosphere is more preferably oxygen, air, or lean air.

It is preferred that calcining in (iii) is carried out at a temperature of the gas atmosphere in the range of from 400 to 600° C., more preferably in the range of from 450 to 550° C., more preferably in the range of from 490 to 510° C.

It is preferred that the gas atmosphere in (iii) comprises nitrogen, oxygen, or a mixture thereof, wherein the gas atmosphere in (iii) is more preferably oxygen, air, or lean air.

Yet further, the present invention relates to a process for production of a molding, preferably of a molding according to any one of the embodiments disclosed herein, comprising a catalyst, the process comprising
(a) preparing a mixture comprising water, a binder or a precursor thereof and a catalyst according to any one of the embodiments disclosed herein;
(b) shaping the mixture obtained from (a), obtaining a precursor of the molding;
(c) calcining the precursor of the molding in a gas atmosphere, obtaining the molding.

It is preferred that the binder in (a) is selected from the group consisting of inorganic binders, wherein the binder more preferably comprises one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides and mixtures of two or more thereof, wherein more preferably the binder comprises one or more sources of silica, wherein more preferably the binder consists of one or more sources of silica, wherein the one or more sources of silica preferably comprise one or more compounds selected from the group consisting of fumed silica, colloidal silica, silica-alumina, colloidal silica-alumina, and mixtures of two or more thereof, more preferably one or more compounds selected from the group consisting of fumed silica, colloidal silica, and mixtures thereof, wherein more preferably the one or more binders consists of fumed silica and/or colloidal silica, and more preferably of colloidal silica.

It is preferred that in the mixture according to (a), a weight ratio of catalyst, relative to Si comprised in the silica binder precursor, calculated as SiO₂, is in the range of from 1:1 to 7:1, more preferably in the range of from 3:1 to 5:1, more preferably in the range of from 3.9:1 to 4.1:1.

It is preferred that in the mixture according to (a), a weight ratio of catalyst, relative to water is in the range of from 0.5:1 to 7:1, more preferably in the range of from 1:1 to 3:1, more preferably in the range of from 1.7:1 to 1.8:1.

It is preferred that the mixture prepared according to (a) further comprises one or more viscosity modifying and/or forming agents.

In the case where the mixture prepared according to (a) further comprises one or more viscosity modifying and/or forming agents, it is preferred that the one or more viscosity modifying and/or pore forming agents are selected from the group consisting of water, alcohols, organic polymers, and mixtures of two or more thereof, wherein the organic polymers are more preferably selected from the group consisting of celluloses, cellulose derivatives, starches, polyalkylene oxides, polystyrenes, polyacrylates, polymethacrylates, polyolefins, polyamides, polyesters, and mixtures of two or more thereof, wherein the organic polymers are more preferably selected from the group consisting of cellulose derivatives, polyalkylene oxides, polystyrenes, and mixtures of two or more thereof, wherein the organic polymers are more preferably selected from the group consisting of methyl celluloses, carboxymethylcelluloses, polyethylene oxides, polystyrenes, and mixtures of two or more thereof, wherein more preferably, the one or more viscosity modifying and/or pore forming agents comprise water, and a carboxymethylcellulose.

It is preferred that in the mixture prepared according to (a), the weight ratio of catalyst relative to the one or more viscosity modifying and/or pore forming agents is in the range of from 10:1 to 30:1, more preferably in the range of from 15:1 to 25:1, more preferably in the range of from 19:1 to 21:1.

It is preferred that preparing the mixture in (a) comprises kneading, more preferably in a kneader or in a mix-muller.

It is preferred that in (b), shaping comprises extruding the mixture.

It is preferred that in (b) the mixture is shaped to a strand, more preferably to a strand having a circular cross-section.

In the case where in (b) the mixture is shaped to a strand having a circular cross-section, it is preferred that the strand having a circular cross-section has a diameter in the range of from 0.2 to 10 mm, more preferably in the range of from 0.5 to 5 mm, more preferably in the range of from 1 to 3 mm, more preferably in the range of from 1.5 to 2.5 mm, more preferably in the range of from 1.9 to 2.1 mm.

It is preferred that shaping according to (b) further comprises drying the precursor of the molding in a gas atmosphere.

In the case where shaping according to (b) further comprises drying the precursor of the molding in a gas atmosphere, it is preferred that drying is carried out at a temperature of the gas atmosphere in the range of from 80 to 160° C., more preferably in the range of from 100 to 140° C., more preferably in the range of from 110 to 130° C.

Further in the case where shaping according to (b) further comprises drying the precursor of the molding in a gas atmosphere, it is preferred that the gas atmosphere comprises nitrogen, oxygen, or a mixture thereof, wherein the gas atmosphere is more preferably oxygen, air, or lean air.

It is preferred that calcining in (c) is carried out at a temperature of the gas atmosphere in the range of from 400 to 600° C., more preferably in the range of from 450 to 550° C., more preferably in the range of from 490 to 510° C.

It is preferred that the gas atmosphere in (c) comprises nitrogen, oxygen, or a mixture thereof, wherein the gas atmosphere is preferably oxygen, air or lean air.

Yet further, the present invention relates to a process for the oxidation of hydrogen chloride to chlorine comprising
(A) providing a reactor comprising a reaction zone which comprises the catalyst according to any one of the embodiments disclosed herein or the molding of any one of the embodiments disclosed herein;
(B) passing a reactant gas stream into the reaction zone obtained from (A), wherein the reactant gas stream passed into the reaction zone comprises hydrogen chloride, and oxygen; subjecting said reactant gas stream to reaction conditions in said reaction zone; and removing a product stream from said reaction zone, said product stream comprising chlorine.

It is preferred that in (A) the catalyst according to any one of the embodiments disclosed herein or the molding of any one of the embodiments disclosed herein is present in a fixed-bed and/or in a fluidized bed, more preferably in a fixed-bed.

It is preferred that in (B) the reaction conditions comprise a temperature in the range of from 300 to 500° C., more preferably in the range of from 360 to 400° C., more preferably in the range of from 370 to 390° C.

It is preferred that in (B) the reaction conditions comprise a pressure in the range of from 0.05 to 2 MPa, more preferably in the range of from 0.1 to 1.5 MPa, more preferably in the range of from 0.15 to 1 MPa, more preferably in the range of from 0.2 to 0.8 MPa, more preferably in the range of from 0.25 to 0.6 MPa, more preferably in the range of from 0.3 to 0.5 MPa, more preferably in the range of from 0.35 to 0.45 MPa, more preferably in the range of from 0.3 to 0.4 MPa.

It is preferred that in (B) the molar ratio of hydrogen chloride to oxygen, HCl : O₂, in the reactant gas stream is in the range of from 1:1 to 5:1, more preferably in the range of from 1.7:1 to 2.3:1, more preferably in the range of from 1.9:1 to 2.1:1.

It is preferred that in (B) the reactant gas stream is fed by a stream comprising hydrogen chloride having a gas hourly space velocity in the range of from 350 to 550 L/(kg*h), more preferably in the range of from 420 to 480 L/(kg*h), more preferably in the range of from 440 to 460 L/(kg*h).

It is preferred that in (B) the reactant gas stream contains from 0.1 to 2.0 wt.-%, more preferably from 0.7 to 1.3 wt.-%, more preferably from 0.9 to 1.1 wt.-%, of H₂O, based on 100 wt.-% of the reactant gas stream.

It is preferred that in (B) the reactant gas stream is fed by a stream comprising hydrogen chloride, wherein the hydrogen chloride is obtained from a reaction of one or more iso- and/or diisocyanates with phosgene, preferably from a reaction of methylenediphenylisocyanate and/or toluenediisocyanate with phosgene.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”.

Further, it is explicitly noted that the following set of embodiments is not the set of claims determining the extent of protection, but represents a suitably structured part of the description directed to general and preferred aspects of the present invention.

According to an embodiment (1), the present invention relates to a catalyst for the oxidation of hydrogen chloride to chlorine, wherein the catalyst comprises an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the inorganic carrier matrix and the zeolite are loaded with copper and with one or more rare earth metals, and wherein the zeolite is supported within the inorganic carrier matrix.

A preferred embodiment (2) concretizing embodiment (1) relates to said catalyst, wherein the inorganic carrier matrix is in the form of microsphere particles having a weight average particle diameter D50 comprised in the range of from 20 to 250 µm, preferably of from 30 to 200 µm, more preferably of from 40 to 150 µm, more preferably of from 50 to 120 µm, more preferably of from 60 to 100 µm, more preferably of from 70 to 90 µm, and more preferably of from 75 to 85 µm, wherein the weight average particle diameter D50 is preferably determined according to ISO 13317-3:2001 and preferably calculated according to ISO 9276-2:2014.

A further preferred embodiment (3) concretizing embodiment (1) or (2) relates to said catalyst, wherein the inorganic carrier matrix displays an Hg-porosity in the range of from 0.1 to 2.5 mL/g, preferably from 0.3 to 1.5 mL/g, more preferably from 0.4 to 1 mL/g, more preferably from 0.5 to 0.75 mL/g, more preferably from 0.55 to 0.65 mL/g, and more preferably from 0.6 to 0.62 mL/g, wherein the Hg-porosity is preferably determined according to ISO 15901-1:2016.

A further preferred embodiment (4) concretizing any one of embodiments (1) to (3) relates to said catalyst, wherein the inorganic carrier matrix displays a BET surface area in the range of from 300 to 600 m²/g, preferably from 350 to 550 m²/g, more preferably from 375 to 500 m²/g, more preferably from 400 to 475 m²/g, more preferably from 425 to 450 m²/g, and more preferably from 440 to 445 m²/g, wherein the BET surface area is preferably determined according to ISO 9277:2010.

A further preferred embodiment (5) concretizing any one of embodiments (1) to (4) relates to said catalyst, wherein the ammonia temperature programmed desorption of the inorganic carrier matrix displays:
a first peak in the range of from 150 to 270° C., preferably of from 170 to 250° C., more preferably of from 190 to 220° C., and more preferably of from 200 to 205° C.;
a second peak in the range of from 270 to 375° C., preferably of from 290 to 355° C., more preferably of from 310 to 335° C., and more preferably of from 320 to 325° C.; and
preferably comprising a third peak in the range of from 535 to 640° C., preferably of from 555 to 620° C., more preferably of from 575 to 600° C., and more preferably of from 585 to 590° C.;
   wherein the integration of the first peak offers a concentration of acid sites in the range of from 0.3 to 1.5 mmol/g, preferably of from 0.5 to 1.3 mmol/g, more preferably of from 0.75 to 1.05 mmol/g, more preferably of from 0.85 to 0.95 mmol/g, and more preferably of from 0.88 to 0.9 mmol/g;
   wherein the integration of the second peak offers a concentration of acid sites in the range of from 0.3 to 1.5 mmol/g, preferably of from 0.5 to 1.3 mmol/g, more preferably of from 0.7 to 1 mmol/g, more preferably of from 0.8 to 0.9 mmol/g, and more preferably of from 0.83 to 0.85 mmol/g; and
   wherein the integration of the preferred third peak offers a concentration of acid sites in the range of from 0.01 to 0.1 mmol/g, preferably of from 0.02 to 0.07 mmol/g, and more preferably of from 0.03 to 0.05 mmol/g.

A further preferred embodiment (6) concretizing any one of embodiments (1) to (5) relates to said catalyst of claim 1 or 5, wherein Y is selected from the group consisting of Si, Sn, Ti, Zr, Ge, and a mixture of two or more thereof, preferably from the group consisting of Si, Ti, Ge, and a mixture of two or more thereof, more preferably from the group consisting of Si, Ti, and a mixture thereof, wherein Y is more preferably Si.

A further preferred embodiment (7) concretizing any one of embodiments (1) to (6) relates to said catalyst, wherein X is selected from the group consisting of B, Al, Ga, In, and a mixture of two or more thereof, preferably from the group consisting of B, Al, Ga, and a mixture of two or more thereof, more preferably from the group consisting of Al, Ga, and a mixture of two or more thereof, wherein X more preferably is Al.

A further preferred embodiment (8) concretizing any one of embodiments (1) to (7) relates to said catalyst, wherein the catalyst comprises Y in an amount ranging from 15 to 45 wt.-%, preferably in the range of from 22 to 35 wt.-%, more preferably in the range of from 26 to 31 wt.-%, more preferably in the range of from 28 to 29 wt.-%, calculated as the element and based on 100 wt.-% of the total amount of Y and X, calculated as the respective oxides YO₂ and X₂O₃, contained in the catalyst.

A further preferred embodiment (9) concretizing any one of embodiments (1) to (8) relates to said catalyst, wherein the catalyst comprises X in an amount ranging from 10 to 30 wt.-%, preferably in the range of from 16 to 25 wt.-%, more preferably in the range of from 18 to 23 wt.-%, more preferably in the range of from 20 to 21 wt.-%, calculated as the element and based on 100 wt.-% of the total amount of Y and X, calculated as the respective oxides YO₂ and X₂O₃, contained in the catalyst.

A further preferred embodiment (10) concretizing any one of embodiments (1) to (9) relates to said catalyst, wherein the catalyst displays a molar ratio Y comprised in the inorganic carrier matrix and the zeolite to X comprised in the inorganic carrier matrix and the zeolite, calculated as YO₂ : X₂O₃, in the range of from 0.5:1 to 10:1, preferably in the range of from 1:1 to 6:1, more preferably in the range of from 2.0:1 to 3.5:1, more preferably in the range of from 2.5:1 to 2.9:1, more preferably in the range of from 2.6:1 to 2.8:1.

A further preferred embodiment (11) concretizing any one of embodiments (1) to (10) relates to said catalyst, wherein the copper loading of the inorganic carrier matrix and the zeolite is in the range of from 2 to 10 wt.-%, preferably in the range of from 5.0 to 9.0 wt.-%, more preferably in the range of from 6.5 to 7.5 wt.-%, more preferably in the range of from 7.0 to 7.2 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (12) concretizing any one of embodiments (1) to (11) relates to said catalyst, wherein the catalyst displays a molar ratio of Y comprised in the inorganic carrier matrix and the zeolite to copper loaded on the inorganic carrier matrix and the zeolite, in the range of from 3 to 15, preferably in the range of from 7 to 11, more preferably in the range of from 9.0:1 to 9.3:1, more preferably in the range of from 9.1:1 to 9.2:1.

A further preferred embodiment (13) concretizing any one of embodiments (1) to (12) relates to said catalyst, wherein the one or more rare earth metals are selected from the group consisting of Sc, Y, La, Ce, Pr, Nd, Sm, Eu, Gd, Tb, Dy, Ho, Er, Tm, Yb, Lu, and a mixture of two or more thereof, preferably from the group consisting of La, Ce, Pr, Nd, Sm, Ho, Lu, and a mixture of two or more thereof, more preferably from the group consisting of Ce, Sm, La, and a mixture of two or more thereof, wherein the inorganic carrier matrix and the zeolite more preferably are loaded with Ce, more preferably with Ce and La, and more preferably with Ce, Sm, and La.

A further preferred embodiment (14) concretizing any one of embodiments (1) to (13) relates to said catalyst, wherein the rare earth metal loading of the inorganic carrier matrix and the zeolite is in the range of from 5 to 50 wt.-%, preferably in the range of from 8 to 30 wt.-%, more preferably in the range of from 10 to 15 wt.-%, more preferably in the range of from 12 to 13 wt.-%, calculated as the sum of the one or more rare earth metals as elements and based on 100 wt.-% of the total amount of Y and X, calculated as the respective oxides YO₂ and X₂O₃, contained in the inorganic carrier matrix and the zeolite.

A further preferred embodiment (15) concretizing any one of embodiments (1) to (14) relates to said catalyst, wherein the inorganic carrier matrix and the zeolite are loaded with Ce.

A further preferred embodiment (16) concretizing embodiment (15) relates to said catalyst, wherein the Ce loading of the inorganic carrier matrix and the zeolite is in the range of from 1 to 6 wt.-%, preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (17) concretizing embodiment (15) or (16) relates to said catalyst, wherein the catalyst displays a molar ratio of Y comprised in the inorganic carrier matrix and in the zeolite to Ce loaded on the inorganic carrier matrix and the zeolite, Y:Ce, in the range of from 25:1 to 75:1, preferably in the range of from 32:1 to 50:1, more preferably in the range of from 38:1 to 43:1, more preferably in the range of from 40:1 to 41:1.

A further preferred embodiment (18) concretizing any one of embodiments (1) to (17) relates to said catalyst, wherein the inorganic carrier matrix and the zeolite are loaded with Sm.

A further preferred embodiment (19) concretizing embodiment (18) relates to said catalyst, wherein the Sm loading of the inorganic carrier matrix and the zeolite is in the range of from 1 to 6 wt.-%, preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (20) concretizing embodiment (18) or (19) relates to said catalyst, wherein the catalyst displays a molar ratio of Y comprised in the inorganic carrier matrix and in the zeolite to Sm loaded on the inorganic carrier matrix and the zeolite, Y:Sm, in the range of from 25:1 to 75:1, preferably in the range of from 35:1 to 52:1, more preferably in the range of from 41:1 to 46:1, more preferably in the range of from 43:1 to 44:1.

A further preferred embodiment (21) concretizing any one of embodiments (1) to (20) relates to said catalyst, wherein the inorganic carrier matrix and the zeolite are loaded with La.

A further preferred embodiment (22) concretizing embodiment (21) relates to said catalyst, wherein the La loading of the inorganic carrier matrix and the zeolite is in the range of from 2 to 8.5 wt.-%, preferably in the range of from 4.0 to 6.5 wt.-%, more preferably in the range of from 5.0 to 5.6 wt.-%, more preferably in the range of from 5.2 to 5.4 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (23) concretizing embodiment (21) or (22) relates to said catalyst, wherein the catalyst displays a molar ratio of Y comprised in the inorganic carrier matrix and in the zeolite to La loaded on the inorganic carrier matrix and the zeolite, Y:La, in the range of from 10:1 to 50:1, preferably in the range of from 20:1 to 33:1, more preferably in the range of from 24:1 to 29:1, more preferably in the range of from 26:1 to 27:1.

A further preferred embodiment (24) concretizing any one of embodiments (1) to (23) relates to said catalyst, wherein the inorganic carrier matrix and the zeolite are further loaded with one or more alkali metals, wherein the one or more alkali metals are preferably selected from the group consisting of Li, Na, K, Rb, Cs, and a mixture of two or more thereof, preferably from the group consisting of Na, K, and a mixture thereof, wherein the one or more alkali metals more preferably are K.

A further preferred embodiment (25) concretizing embodiment (24) relates to said catalyst, wherein the alkali metal loading of the inorganic carrier matrix and the zeolite is in the range of from 1 to 7.5 wt.-%, preferably in the range of from 3.0 to 5.5 wt.-%, more preferably in the range of from 4.0 to 4.6 wt.-%, more preferably in the range of from 4.2 to 4.4 wt.-%, calculated as the sum of the one or more alkali metals as elements and based on 100 wt.-% of the total amount of Y and X, calculated as the respective oxides YO₂ and X₂O₃, contained in the inorganic carrier matrix and the zeolite.

A further preferred embodiment (26) concretizing embodiment (24) or (25) relates to said catalyst, wherein the catalyst displays a molar ratio of Y comprised in the inorganic carrier matrix and in the zeolite to the one or more alkali metals loaded on the inorganic carrier matrix and the zeolite in the range of from 1:1 to 20:1, preferably in the range of from 5:1 to 15:1, more preferably in the range of from 8:1 to 11:1, more preferably in the range of from 9:1 to 10:1.

A further preferred embodiment (27) concretizing any one of embodiments (1) to (26) relates to said catalyst, wherein the inorganic carrier matrix comprises one or more inorganic oxides selected from the group consisting of silica, alumina, titania, zirconia, magnesia, clays, and a mixture of two or more thereof, preferably from the group consisting of a montmorillonite, a kaolin, a metakaolin, a bentonite, a halloysite, a dickite, a nacrite, an anauxite, and a mixture of two or more thereof, more preferably from the group consisting of a kaolin, a metakaolin, and a mixture thereof.

A further preferred embodiment (28) concretizing any one of embodiments (1) to (27) relates to said catalyst, wherein the catalyst displays a BET surface area in the range of from 100 to 600 m²/g, preferably in the range of from 250 to 450 m²/g, more preferably in the range of from 310 to 380 m²/g, more preferably in the range of from 330 to 360 m²/g, more preferably in the range of from 340 to 350 m²/g, wherein the BET surface area is preferably determined according to ISO 9277:2010.

A further preferred embodiment (29) concretizing any one of embodiments (1) to (28) relates to said catalyst, wherein the zeolite has a framework structure type selected from the group consisting of FAU, GIS, MOR, LTA, FER, TON, MTT, BEA, MEL, MWW, MFS, MFI, and a mixed type of two or more thereof, preferably from the group consisting of FAU, GIS, BEA, MFI, and mixed type of two or more thereof, wherein the zeolite more preferably has an FAU and/or BEA framework structure type, and more preferably an FAU framework structure type.

A further preferred embodiment (30) concretizing any one of embodiments (1) to (29) relates to said catalyst, wherein the zeolite has an FAU framework structure type, wherein the zeolite preferably is selected from the group consisting of ZSM-3, Faujasite, [AI-Ge-O]-FAU, CSZ-1, ECR-30, Zeolite X, Zeolite Y, LZ-210, SAPO-37, ZSM-20, Na-X, US-Y, Na-Y, [Ga-Ge-O]-FAU, Li-LSX, [Ga-Al-Si-O]-FAU, [Ga-Si-O]-FAU, and a mixture of two or more thereof, more preferably from the group consisting of ZSM-3, Faujasite, CSZ-1, ECR-30, Zeolite X, Zeolite Y, LZ-210, ZSM-20, Na-X, US-Y, Na-Y, Li-LSX, and a mixture of two or more thereof, more preferably from the group consisting of Faujasite, Zeolite X, Zeolite Y, Na-X, US-Y, Na-Y, and a mixture of two or more thereof, more preferably from the group consisting of Faujasite, Zeolite X, Zeolite Y, and a mixture of two or more thereof, wherein more preferably the zeolite having an FAU framework structure type comprises Zeolite X and/or Zeolite Y, preferably Zeolite Y, wherein more preferably the zeolite having an FAU framework structure type is Zeolite X and/or Zeolite Y, preferably Zeolite Y.

A further preferred embodiment (31) concretizing any one of embodiments (1) to (30) relates to said catalyst, wherein the catalyst comprises the zeolite in an amount in the range of from 10 to 90 wt.-%, preferably in the range of from 20 to 80 wt.-%, more preferably in the range of from 30 to 70 wt.-%, more preferably in the range of from 40 to 60 wt.-%, and more preferably in the range of from 45 to 55 wt.-%, based on 100 wt.-% of the total amount of Y and X, calculated as the respective oxides YO₂ and X₂O₃, contained in the catalyst.

A further preferred embodiment (32) concretizing any one of embodiments (1) to (31) relates to said catalyst, wherein the catalyst comprises the inorganic carrier matrix in an amount in the range of from 10 to 90 wt.-%, preferably in the range of from 20 to 80 wt.-%, more preferably in the range of from 30 to 70 wt.-%, more preferably in the range of from 40 to 60 wt.-%, and more preferably in the range of from 45 to 55 wt.-%, based on 100 wt.-% of the total amount of Y and X, calculated as the respective oxides YO₂ and X₂O₃, contained in the catalyst.

A further preferred embodiment (33) concretizing any one of embodiments (1) to (32) relates to said catalyst, wherein the catalyst comprises from 0 to 1 wt.-%, preferably from 0 to 0.1 wt.-%, more preferably from 0 to 0.01 wt.-%, more preferably from 0 to 0.001 wt.-% of Cl, calculated as the element, based on 100 wt.-% of the catalyst.

An embodiment (34) relates to a molding comprising the catalyst according to any one of embodiments (1) to (33).

A preferred embodiment (35) concretizing embodiment (34) relates to said molding, wherein the molding displays a BET surface area which is comprised in the range of from 50 to 600 m²/g, preferably in the range of from 150 to 450 m²/g, more preferably in the range of from 220 to 360 m²/g, more preferably in the range of from 270 to 310 m²/g, more preferably in the range of from 280 to 300 m²/g, wherein the BET surface area is preferably determined according to ISO 9277:2010.

A further preferred embodiment (36) concretizing embodiment (34) or (35) relates to said molding, wherein the molding displays a total pore volume comprised in the range of from 0.2 to 0.4 cm³/g, preferably in the range of from 0.26 to 0.33 cm³/g, more preferably in the range of from 0.29 to 0.30 cm³/g, wherein the total pore volume is preferably determined according to ISO 15901-2:2006.

A further preferred embodiment (37) concretizing any one of embodiments (34) to (36) relates to said molding, wherein the molding displays a micropore volume comprised in the range of from 0.01 to 0.20 cm³/g, preferably in the range of from 0.05 to 0.15 cm³/g, more preferably in the range of from 0.09 to 0.11 cm³/g, wherein the micropore volume is preferably determined according to ISO 15901-3:2007.

A further preferred embodiment (38) concretizing any one of embodiments (34) to (37) relates to said molding, wherein the molding displays an adsorption average pore width (4V/A) comprised in the range of from 1 to 8 nm, preferably in the range of from 3.5 to 5.0 nm, more preferably in the range of from 4.0 to 4.2 nm, wherein the adsorption average pore width (4V/A) is preferably determined according to ISO 15901-2:2006.

A further preferred embodiment (39) concretizing any one of embodiments (34) to (38) relates to said molding, wherein the molding displays a desorption average pore diameter (4V/A) comprised in the range of from 5 to 15 nm, preferably in the range of from 9.0 to 11.0 nm, more preferably in the range of from 9.7 to 9.9 nm, wherein the desorption average pore diameter (4V/A) is preferably determined according to DIN 66134:1998-02.

A further preferred embodiment (40) concretizing any one of embodiments (34) to (39) relates to said molding, wherein the copper loading of the molding is in the range of from 2 to 10 wt.-%, preferably in the range of from 5.0 to 6.5 wt.-%, more preferably in the range of from 5.5 to 5.9 wt.-%, more preferably in the range of from 5.6 to 5.8 wt.-%, calculated as the element and based on 100 wt.-% of the total amount of Y and X, calculated as the respective oxides YO₂ and X₂O₃, contained in the molding.

A further preferred embodiment (41) concretizing any one of embodiments (34) to (40) relates to said molding, wherein the molding displays a molar ratio of Y contained in the molding to copper contained in the molding, in the range of from 10 to 20, preferably in the range of from 12 to 15, more preferably in the range of from 13.3:1 to 13.9:1, more preferably in the range of from 13.5:1 to 13.7:1.

A further preferred embodiment (42) concretizing any one of embodiments (34) to (41) relates to said molding, wherein the rare earth metal loading of the molding is in the range of from 5 to 15 wt.-% wt.-%, preferably in the range of from 9.0 to 10.5 wt.-%, more preferably in the range of from 9.4 to 9.8 wt.-%, more preferably in the range of from 9.5 to 9.7 wt.-%, calculated as the element(s) and based on 100 wt.-% of the total amount of Y and X, calculated as the respective oxides YO₂ and X₂O₃, contained in the molding.

A further preferred embodiment (43) concretizing any one of embodiments (34) to (42) relates to said molding, wherein the inorganic carrier matrix and the zeolite are loaded with Ce, wherein the Ce loading of the molding is preferably in the range of from 1 to 5 wt.-% wt.-%, more preferably in the range of from 2.0 to 3.5 wt.-%, more preferably in the range of from 2.5 to 2.9 wt.-%, more preferably in the range of from 2.6 to 2.8 wt.-%, calculated as the element and based on 100 wt.-% of the total amount of Y and X, calculated as the respective oxides YO₂ and X₂O₃, contained in the molding.

A further preferred embodiment (44) concretizing embodiment (43) relates to said molding, wherein the molding displays a molar ratio of Y comprised in the inorganic carrier matrix and in the zeolite to Ce loaded on the inorganic carrier matrix and the zeolite, Y:Ce, in the range of from 25:1 to 100:1, preferably in the range of from 55:1 to 70:1, more preferably in the range of from 60:1 to 66:1, more preferably in the range of from 62:1 to 64:1.

A further preferred embodiment (45) concretizing any one of embodiments (34) to (44) relates to said molding, wherein the inorganic carrier matrix and the zeolite are loaded with Sm, wherein the Sm loading of the molding is preferably in the range of from 1 to 5 wt.-%, more preferably in the range of from 2.0 to 3.5 wt.-%, more preferably in the range of from 2.5 to 2.9 wt.-%, more preferably in the range of from 2.6 to 2.8 wt.-%, calculated as the element and based on 100 wt.-% of the total amount of Y and X, calculated as the respective oxides YO₂ and X₂O₃, contained in the molding.

A further preferred embodiment (46) concretizing embodiment (45) relates to said molding, wherein the molding displays a molar ratio of Y comprised in the inorganic carrier matrix and in the zeolite to Sm loaded on the inorganic carrier matrix and the zeolite, Y:Sm, in the range of from 30:1 to 120:1, preferably in the range of from 60:1 to 90:1, more preferably in the range of from 65:1 to 70:1, more preferably in the range of from 66.5:1 to 68.5:1.

A further preferred embodiment (47) concretizing any one of embodiments (34) to (46) relates to said molding, wherein the inorganic carrier matrix and the zeolite are loaded with La, wherein the La loading of the molding is preferably in the range of from 2 to 8 wt.-% wt.-%, more preferably in the range of from 3.5 to 5.0 wt.-%, more preferably in the range of from 4.0 to 4.4 wt.-%, more preferably in the range of from 4.1 to 4.3 wt.-%, calculated as the element and based on 100 wt.-% of the total amount of Y and X, calculated as the respective oxides YO₂ and X₂O₃, contained in the molding.

A further preferred embodiment (48) concretizing embodiment (47) relates to said molding, wherein the molding displays a molar ratio of Y comprised in the inorganic carrier matrix and in the zeolite to La loaded on the inorganic carrier matrix and the zeolite, Y:La, in the range of from 25:1 to 75:1, preferably in the range of from 33:1 to 47:1, more preferably in the range of from 38:1 to 42:1, more preferably in the range of from 39:1 to 41:1.

A further preferred embodiment (49) concretizing any one of embodiments (34) to (48) relates to said molding, wherein the inorganic carrier matrix and the zeolite are further loaded with K, wherein the K loading of the molding is preferably in the range of from 1 to 7 wt.-% wt.-%, more preferably in the range of from 3.0 to 4.5 wt.-%, more preferably in the range of from 3.5 to 3.9 wt.-%, more preferably in the range of from 3.6 to 3.8 wt.-%, calculated as the element and based on 100 wt.-% of the total amount of Y and X, calculated as the respective oxides YO₂ and X₂O₃, contained in the molding.

A further preferred embodiment (50) concretizing embodiment (49) relates to said molding, wherein the molding displays a molar ratio of Y comprised in the inorganic carrier matrix and in the zeolite to K loaded on the inorganic carrier matrix and the zeolite, Y:K, in the range of from 1:1 to 30:1, preferably in the range of from 7:1 to 20:1, more preferably in the range of from 10:1 to 16:1, more preferably in the range of from 12:1 to 14:1.

A further preferred embodiment (51) concretizing any one of embodiments (34) to (50) relates to said molding, wherein the molding comprises Y in an amount ranging from 10 to 60 wt.-%, preferably in the range of from 25 to 45 wt.-%, more preferably in the range of from 32 to 36 wt.-%, more preferably in the range of from 33 to 35 wt.-%, calculated as the element and based on 100 wt.-% of the total amount of Y and X, calculated as the respective oxides YO₂ and X₂O₃, contained in the molding.

A further preferred embodiment (52) concretizing any one of embodiments (34) to (51) relates to said molding, wherein the molding comprises X in an amount ranging from 5 to 25 wt.-%, preferably in the range of from 10 to 18 wt.-%, more preferably in the range of from 12 to 16 wt.-%, more preferably in the range of from 13 to 15 wt.-%, calculated as the element and based on 100 wt.-% of the total amount of Y and X, calculated as the respective oxides YO₂ and X₂O₃, contained in the molding.

A further preferred embodiment (53) concretizing any one of embodiments (34) to (52) relates to said molding, wherein the molding displays a molar ratio of Y contained in the molding to X contained in the molding, calculated as YO₂ : X₂O₃, in the range of from 1:1 to 8:1, preferably in the range of from 3:1 to 6:1, more preferably in the range of from 4.0:1 to 5.0:1, more preferably in the range of from 4.4:1 to 4.8:1, more preferably in the range of from 4.5:1 to 4.7:1.

A further preferred embodiment (54) concretizing any one of embodiments (34) to (53) relates to said molding, wherein the hydrogen temperature programmed reduction of the molding displays:
a first peak in the range of from 175 to 225° C., preferably of from 185 to 210° C., more preferably of from 190 to 200° C., and more preferably of from 193 to 198° C.; and
a second peak in the range of from 175 to 275° C., preferably of from 200 to 250° C., more preferably of from 215 to 240° C., and more preferably of from 225 to 230° C.; and wherein the integration of the first peak offers a concentration of reducible sites in the range of from 50 to 250 µmol/g, preferably of from 75 to 225 µmol/g, more preferably of from 100 to 200 µmol/g, more preferably of from 125 to 175 µmol/g, and more preferably of from 150 to 155 µmol/g; and
   wherein the integration of the second peak offers a concentration of reducible sites in the range of from 225 to 600 µmol/g, preferably of from 250 to 450 µmol/g, more preferably of from 275 to 400 µmol/g, more preferably of from 300 to 350 µmol/g, and more preferably of from 315 to 325 µmol/g.

An embodiment (55) of the present invention relates to a process for the production of a catalyst, preferably of a catalyst according to any one of embodiments (1) to (33), for the oxidation of hydrogen chloride to chlorine, the process comprising
(i) providing a carrier comprising an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the zeolite is supported within the inorganic carrier matrix;
(ii) subjecting the carrier to one or more ion-exchange procedures with copper, further with one or more rare earth metals, and preferably further with one or more alkali metals, obtaining a precursor of the catalyst;
(iii) calcining the precursor of the catalyst in a gas atmosphere, obtaining the catalyst.

A preferred embodiment (56) concretizing embodiment (55) relates to said process, wherein the inorganic carrier matrix is in the form of microsphere particles having a weight average particle diameter D50 comprised in the range of from 20 to 250 µm, preferably of from 30 to 200 µm, more preferably of from 40 to 150 µm, more preferably of from 50 to 120 µm, more preferably of from 60 to 100 µm, more preferably of from 70 to 90 µm, and more preferably of from 75 to 85 µm, wherein the weight average particle diameter D50 is preferably determined according to ISO 13317-3:2001 and preferably calculated according to ISO 9276-2:2014.

A further preferred embodiment (57) concretizing embodiment (55) or (56) relates to said process, wherein the inorganic carrier matrix displays an Hg-porosity in the range of from 0.1 to 2.5 mL/g, preferably from 0.3 to 1.5 mL/g, more preferably from 0.4 to 1 mL/g, more preferably from 0.5 to 0.75 mL/g, more preferably from 0.55 to 0.65 mL/g, and more preferably from 0.6 to 0.62 mL/g, wherein the Hg-porosity is preferably determined according to ISO 15901-1:2016.

A further preferred embodiment (58) concretizing any one of embodiments (55) to (57) relates to said process, wherein the inorganic carrier matrix displays a BET surface area in the range of from 300 to 600 m²/g, preferably from 350 to 550 m²/g, more preferably from 375 to 500 m²/g, more preferably from 400 to 475 m²/g, more preferably from 425 to 450 m²/g, and more preferably from 440 to 445 m²/g, wherein the BET surface area is preferably determined according to ISO 9277:2010.

A further preferred embodiment (59) concretizing any one of embodiments (55) to (58) relates to said prcoess, wherein the ammonia temperature programmed desorption of the inorganic carrier matrix displays:
a first peak in the range of from 150 to 270° C., preferably of from 170 to 250° C., more preferably of from 190 to 220° C., and more preferably of from 200 to 205° C.;
a second peak in the range of from 270 to 375° C., preferably of from 290 to 355° C., more preferably of from 310 to 335° C., and more preferably of from 320 to 325° C.; and
preferably comprising a third peak in the range of from 535 to 640° C., preferably of from 555 to 620° C., more preferably of from 575 to 600° C., and more preferably of from 585 to 590° C.;
   wherein the integration of the first peak offers a concentration of acid sites in the range of from 0.3 to 1.5 mmol/g, preferably of from 0.5 to 1.3 mmol/g, more preferably of from 0.75 to 1.05 mmol/g, more preferably of from 0.85 to 0.95 mmol/g, and more preferably of from 0.88 to 0.9 mmol/g;
   wherein the integration of the second peak offers a concentration of acid sites in the range of from 0.3 to 1.5 mmol/g, preferably of from 0.5 to 1.3 mmol/g, more preferably of from 0.7 to 1 mmol/g, more preferably of from 0.8 to 0.9 mmol/g, and more preferably of from 0.83 to 0.85 mmol/g; and
   wherein the integration of the preferred third peak offers a concentration of acid sites in the range of from 0.01 to 0.1 mmol/g, preferably of from 0.02 to 0.07 mmol/g, and more preferably of from 0.03 to 0.05 mmol/g.

A further preferred embodiment (60) concretizing any one of embodiments (55) to (59) relates to said process, wherein Y is selected from the group consisting of Si, Sn, Ti, Zr, Ge, and a mixture of two or more thereof, preferably from the group consisting of Si, Ti, Ge, and a mixture of two or more thereof, more preferably from the group consisting of Si, Ti, and a mixture thereof, wherein Y is more preferably Si.

A further preferred embodiment (61) concretizing any one of embodiments (55) to (60) relates to said process, wherein X is selected from the group consisting of B, Al, Ga, In, and a mixture of two or more thereof, preferably from the group consisting of B, Al, Ga, and a mixture of two or more thereof, more preferably from the group consisting of Al, Ga, and a mixture of two or more thereof, wherein X more preferably is Al.

A further preferred embodiment (62) concretizing any one of embodiments (55) to (61) relates to said process, wherein the carrier comprises Y in an amount ranging from 15 to 45 wt.-%, preferably in the range of from 22 to 35 wt.-%, more preferably in the range of from 26 to 31 wt.-%, more preferably in the range of from 28 to 29 wt.-%, calculated as the element and based on 100 wt.-% of the total amount of Y and X, calculated as the respective oxides YO₂ and X₂O₃, contained in the carrier.

A further preferred embodiment (63) concretizing any one of embodiments (55) to (62) relates to said process, wherein the carrier comprises X in an amount ranging from 10 to 30 wt.-%, preferably in the range of from 16 to 25 wt.-%, more preferably in the range of from 18 to 23 wt.-%, more preferably in the range of from 20 to 21 wt.-%, calculated as the element and based on 100 wt.-% of the total amount of Y and X, calculated as the respective oxides YO₂ and X₂O₃, contained in the carrier.

A further preferred embodiment (64) concretizing any one of embodiments (55) to (63) relates to said process, wherein the carrier displays a molar ratio Y comprised in the inorganic carrier matrix and the zeolite to X comprised in the inorganic carrier matrix and the zeolite, calculated as YO₂ : X₂O₃, in the range of from 0.5:1 to 10:1, preferably in the range of from 1:1 to 6:1, more preferably in the range of from 2.0:1 to 3.5:1, more preferably in the range of from 2.5:1 to 2.9:1, more preferably in the range of from 2.6:1 to 2.8:1.

A further preferred embodiment (65) concretizing any one of embodiments (55) to (64) relates to said process, wherein in the catalyst obtained in (iii) the copper loading of the inorganic carrier matrix and the zeolite is in the range of from 2 to 10 wt.-%, preferably in the range of from 5.0 to 9.0 wt.-%, more preferably in the range of from 6.5 to 7.5 wt.-%, more preferably in the range of from 7.0 to 7.2 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (66) concretizing any one of embodiments (55) to (65) relates to said process, wherein the catalyst obtained in (iii) displays a molar ratio of Y comprised in the inorganic carrier matrix and the zeolite to copper loaded on the inorganic carrier matrix and the zeolite, in the range of from 3 to 15, preferably in the range of from 7 to 11, more preferably in the range of from 9.0:1 to 9.3:1, more preferably in the range of from 9.1:1 to 9.2:1.

A further preferred embodiment (67) concretizing any one of embodiments (55) to (66) relates to said process, wherein the one or more rare earth metals are selected from the group consisting of Sc, Y, La, Ce, Pr, Nd, Sm, Eu, Gd, Tb, Dy, Ho, Er, Tm, Yb, Lu, and a mixture of two or more thereof, preferably from the group consisting of La, Ce, Pr, Nd, Sm, Ho, Lu, and a mixture of two or more thereof, more preferably from the group consisting of Ce, Sm, La, and a mixture of two or more thereof, wherein the inorganic carrier matrix and the zeolite more preferably are loaded with Ce, more preferably with Ce and La, and more preferably with Ce, Sm, and La.

A further preferred embodiment (68) concretizing any one of embodiments (55) to (67) relates to said process, wherein in the catalyst obtained in (iii) the rare earth metal loading of the inorganic carrier matrix and the zeolite is in the range of from 5 to 20 wt.-%, preferably in the range of from 8 to 17 wt.-%, more preferably in the range of from 10 to 15 wt.-%, more preferably in the range of from 12 to 13 wt.-%, calculated as the sum of the one or more rare earth metals as elements and based on 100 wt.-% of the total amount of Y and X, calculated as the respective oxides YO₂ and X₂O₃, contained in the inorganic carrier matrix and the zeolite.

A further preferred embodiment (69) concretizing any one of embodiments (55) to (68) relates to said process, wherein in (ii) the carrier is loaded with Ce.

A further preferred embodiment (70) concretizing embodiment (69) relates to said process, wherein in the catalyst obtained in (iii) the Ce loading of the carrier is in the range of from 1 to 6 wt.-%, preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (71) concretizing embodiment (69) or (70) relates to said process, wherein the catalyst obtained in (iii) displays a molar ratio of Y comprised in the inorganic carrier matrix and in the zeolite to Ce loaded on the inorganic carrier matrix and the zeolite, Y:Ce, in the range of from 25:1 to 75:1, preferably in the range of from 32:1 to 50:1, more preferably in the range of from 38:1 to 43:1, more preferably in the range of from 40:1 to 41:1.

A further preferred embodiment (72) concretizing any one of embodiments (55) to (71) relates to said process, wherein in (ii) the carrier is loaded with Sm.

A further preferred embodiment (73) concretizing embodiment (72) relates to said process, wherein in the catalyst obtained in (iii) the Sm loading of the inorganic carrier matrix and the zeolite is in the range of from 1 to 6 wt.-%, preferably in the range of from 3.0 to 4.0 wt.-%, more preferably in the range of from 3.2 to 3.8 wt.-%, more preferably in the range of from 3.4 to 3.6 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (74) concretizing embodiment (72) or (73) relates to said process, wherein the catalyst obtained in (iii) displays a molar ratio of Y comprised in the inorganic carrier matrix and in the zeolite to Sm loaded on the inorganic carrier matrix and the zeolite, Y:Sm, in the range of from 25:1 to 75:1, preferably in the range of from 35:1 to 52:1, more preferably in the range of from 41:1 to 46:1, more preferably in the range of from 43:1 to 44:1.

A further preferred embodiment (75) concretizing any one of embodiments (55) to (74) relates to said process, wherein in (ii) the carrier is loaded with La.

A further preferred embodiment (76) concretizing embodiment (75) relates to said process, wherein in the catalyst obtained in (iii) the La loading of the inorganic carrier matrix and the zeolite is in the range of from 2 to 8.5 wt.-%, preferably in the range of from 4.0 to 6.5 wt.-%, more preferably in the range of from 5.0 to 5.6 wt.-%, more preferably in the range of from 5.2 to 5.4 wt.-%, calculated as the element and based on 100 wt.-% of the total amount of Y and X, calculated as the respective oxides YO₂ and X₂O₃, contained in the inorganic carrier matrix and the zeolite.

A further preferred embodiment (77) concretizing embodiment (75) or (76) relates to said process, wherein the catalyst obtained in (iii) displays a molar ratio of Y comprised in the inorganic carrier matrix and in the zeolite to La loaded on the inorganic carrier matrix and the zeolite, Y:La, in the range of from 10:1 to 50:1, preferably in the range of from 20:1 to 33:1, more preferably in the range of from 24:1 to 29:1, more preferably in the range of from 26:1 to 27:1.

A further preferred embodiment (78) concretizing any one of embodiments (55) to (77) relates to said process, wherein in (ii) the carrier is further loaded with one or more alkali metals, wherein the one or more alkali metals are preferably selected from the group consisting of Li, Na, K, Rb, Cs, and a mixture of two or more thereof, preferably from the group consisting of Na, K, and a mixture thereof, wherein the one or more alkali metals more preferably are K.

A further preferred embodiment (79) concretizing embodiment (78) relates to said process, wherein in the catalyst obtained in (iii) the alkali metal loading of the inorganic carrier matrix and the zeolite is in the range of from 1 to 7.5 wt.-%, preferably in the range of from 3.0 to 5.5 wt.-%, more preferably in the range of from 4.0 to 4.6 wt.-%, more preferably in the range of from 4.2 to 4.4 wt.-%, calculated as the sum of the one or more alkali metals as elements and based on 100 wt.-% of the total amount of Y and X, calculated as the respective oxides YO₂ and X₂O₃, contained in the inorganic carrier matrix and the zeolite.

A further preferred embodiment (80) concretizing embodiment (78) or (79) relates to said process, wherein the catalyst obtained in (iii) displays a molar ratio of Y comprised in the inorganic carrier matrix and in the zeolite to the one or more alkali metals loaded on the inorganic carrier matrix and the zeolite in the range of from 1:1 to 20:1, preferably in the range of from 5:1 to 15:1, more preferably in the range of from 8:1 to 11:1, more preferably in the range of from 9:1 to 10:1.

A further preferred embodiment (81) concretizing any one of embodiments (55) to (80) relates to said process, wherein the inorganic carrier matrix comprises one or more inorganic oxides selected from the group consisting of silica, alumina, titania, zirconia, magnesia, clays, and a mixture of two or more thereof, preferably from the group consisting of a montmorillonite, a kaolin, a metakaolin, a bentonite, a halloysite, a dickite, a nacrite, an anauxite, and a mixture of two or more thereof, more preferably from the group consisting of a kaolin, a metakaolin, and a mixture thereof.

A further preferred embodiment (82) concretizing any one of embodiments (55) to (81) relates to said process, wherein the catalyst obtained in (iii) displays a BET surface area in the range of from 100 to 600 m²/g, preferably in the range of from 250 to 450 m²/g, more preferably in the range of from 310 to 380 m²/g, more preferably in the range of from 330 to 360 m²/g, more preferably in the range of from 340 to 350 m²/g, wherein the BET surface area is preferably determined according to ISO 9277:2010.

A further preferred embodiment (83) concretizing any one of embodiments (55) to (82) relates to said process, wherein the zeolite has a framework structure type selected from the group consisting of FAU, GIS, MOR, LTA, FER, TON, MTT, BEA, MEL, MWW, MFS, MFI, and a mixed type of two or more thereof, preferably from the group consisting of FAU, GIS, BEA, MFI, and mixed type of two or more thereof, wherein the zeolite more preferably has an FAU and/or BEA framework structure type, and more preferably an FAU framework structure type.

A further preferred embodiment (84) concretizing embodiment (83) relates to said process, wherein the zeolite has an FAU framework structure type, wherein the zeolite preferably is selected from the group consisting of ZSM-3, Faujasite, [AI-Ge-O]-FAU, CSZ-1, ECR-30, Zeolite X, Zeolite Y, LZ-210, SAPO-37, ZSM-20, Na-X, US-Y, Na-Y, [Ga-Ge-O]-FAU, Li-LSX, [Ga-Al-Si-O]-FAU, [Ga-Si-O]-FAU, and a mixture of two or more thereof, more preferably from the group consisting of ZSM-3, Faujasite, CSZ-1, ECR-30, Zeolite X, Zeolite Y, LZ-210, ZSM-20, Na-X, US-Y, Na-Y, Li-LSX, and a mixture of two or more thereof, more preferably from the group consisting of Faujasite, Zeolite X, Zeolite Y, Na-X, US-Y, Na-Y, and a mixture of two or more thereof, more preferably from the group consisting of Faujasite, Zeolite X, Zeolite Y, and a mixture of two or more thereof, wherein more preferably the zeolite having an FAU framework structure type comprises Zeolite X and/or Zeolite Y, preferably Zeolite Y, wherein more preferably the zeolite having an FAU framework structure type is Zeolite X and/or Zeolite Y, preferably Zeolite Y.

A further preferred embodiment (85) concretizing any one of embodiments (55) to (84) relates to said process, wherein the carrier comprises the zeolite in an amount in the range of from 68 to 90 wt.-%, preferably in the range of from 74 to 84 wt.-%, more preferably in the range of from 77 to 81 wt.-%, based on 100 wt.-% of the total amount of Y and X, calculated as the respective oxides YO₂ and X₂O₃, contained in the catalyst.

A further preferred embodiment (86) concretizing any one of embodiments (55) to (85) relates to said process, wherein the carrier comprises the inorganic carrier matrix in an amount in the range of from 10 to 32 wt.-%, preferably in the range of from 16 to 26 wt.-%, more preferably in the range of from 19 to 23 wt.-%, based on 100 wt.-% of the total amount of Y and X, calculated as the respective oxides YO₂ and X₂O₃, contained in the catalyst.

A further preferred embodiment (87) concretizing any one of embodiments (55) to (86) relates to said process, wherein the catalyst obtained in (iii) comprises from 0 to 1 wt.-%, preferably from 0 to 0.1 wt.-%, more preferably from 0 to 0.01 wt.-%, more preferably from 0 to 0.001 wt.-% of Cl, calculated as the element, based on 100 wt.-% of the catalyst.

A further preferred embodiment (88) concretizing any one of embodiments (55) to (87) relates to said process, wherein the one or more ion-exchange procedures are performed at a temperature in the range of from 25 to 110° C., preferably in the range of from 50 to 90° C., more preferably in the range of from 70 to 85° C.

A further preferred embodiment (89) concretizing any one of embodiments (55) to (88) relates to said process, wherein subjecting the carrier to ion-exchange comprises drying of the precursor of the catalyst in a gas atmosphere having a temperature in the range of from 70 to 150° C., preferably in the range of from 90 to 130° C., more preferably in the range of from 100 to 120° C.

A further preferred embodiment (90) concretizing embodiment (89) relates to said process, wherein the gas atmosphere comprises nitrogen, oxygen, or a mixture thereof, wherein the gas atmosphere is preferably oxygen, air, or lean air.

A further preferred embodiment (91) concretizing any one of embodiments (55) to (90) relates to said process, wherein calcining in (iii) is carried out at a temperature of the gas atmosphere in the range of from 400 to 600° C., preferably in the range of from 450 to 550° C., more preferably in the range of from 490 to 510° C.

A further preferred embodiment (92) concretizing embodiment (91) relates to said process, wherein the gas atmosphere in (iii) comprises nitrogen, oxygen, or a mixture thereof, wherein the gas atmosphere in (iii) is preferably oxygen, air, or lean air.

An embodiment (93) of the present invention relates to a process for production of a molding, preferably of a molding according to any one of embodiments (34) to (54), comprising a catalyst, the process comprising
(a) preparing a mixture comprising water, a binder or a precursor thereof and a catalyst according to any one of embodiments (1) to (33);
(b) shaping the mixture obtained from (a), obtaining a precursor of the molding;
(c) calcining the precursor of the molding in a gas atmosphere, obtaining the molding.

A preferred embodiment (94) concretizing embodiment (93) relates to said process, wherein the binder is selected from the group consisting of inorganic binders, wherein the binder preferably comprises one or more sources of a metal oxide and/or of a metalloid oxide, more preferably one or more sources of a metal oxide and/or of a metalloid oxide selected from the group consisting of silica, alumina, titania, zirconia, lanthana, magnesia, and mixtures and/or mixed oxides of two or more thereof, more preferably from the group consisting of silica, alumina, titania, zirconia, magnesia, silica-alumina mixed oxides, silica-titania mixed oxides, silica-zirconia mixed oxides, silica-lanthana mixed oxides, silica-zirconia-lanthana mixed oxides, alumina-titania mixed oxides, alumina-zirconia mixed oxides alumina-lanthana mixed oxides, alumina-zirconia-lanthana mixed oxides, titania-zirconia mixed oxides, and mixtures and/or mixed oxides of two or more thereof, more preferably from the group consisting of silica, alumina, silica-alumina mixed oxides and mixtures of two or more thereof, wherein more preferably the binder comprises one or more sources of silica, wherein more preferably the binder consists of one or more sources of silica, wherein the one or more sources of silica preferably comprise one or more compounds selected from the group consisting of fumed silica, colloidal silica, silica-alumina, colloidal silica-alumina, and mixtures of two or more thereof, more preferably one or more compounds selected from the group consisting of fumed silica, colloidal silica, and mixtures thereof, wherein more preferably the one or more binders consists of fumed silica and/or colloidal silica, and more preferably of colloidal silica.

A further preferred embodiment (95) concretizing embodiment (93) or (94) relates to said process, wherein in the mixture according to (a), a weight ratio of catalyst, relative to Si comprised in the silica binder precursor, calculated as SiO₂, is in the range of from 1:1 to 7:1, preferably in the range of from 3:1 to 5:1, more preferably in the range of from 3.9:1 to 4.1:1.

A further preferred embodiment (96) concretizing any one of embodiments (93) to (95) relates to said process, wherein in the mixture according to (a), a weight ratio of catalyst, relative to water is in the range of from 0.5:1 to 7:1, preferably in the range of from 1:1 to 3:1, more preferably in the range of from 1.7:1 to 1.8:1.

A further preferred embodiment (97) concretizing any one of embodiments (93) to (96) relates to said process, wherein the mixture prepared according to (a) further comprises one or more viscosity modifying and/or forming agents.

A further preferred embodiment (98) concretizing embodiment (97) relates to said process, wherein the one or more viscosity modifying and/or pore forming agents are selected from the group consisting of water, alcohols, organic polymers, and mixtures of two or more thereof, wherein the organic polymers are preferably selected from the group consisting of celluloses, cellulose derivatives, starches, polyalkylene oxides, polystyrenes, polyacrylates, polymethacrylates, polyolefins, polyamides, polyesters, and mixtures of two or more thereof, wherein the organic polymers are more preferably selected from the group consisting of cellulose derivatives, polyalkylene oxides, polystyrenes, and mixtures of two or more thereof, wherein the organic polymers are more preferably selected from the group consisting of methyl celluloses, carboxymethylcelluloses, polyethylene oxides, polystyrenes, and mixtures of two or more thereof, wherein more preferably, the one or more viscosity modifying and/or pore forming agents comprise water, and a carboxymethylcellulose.

A further preferred embodiment (99) concretizing embodiment (97) or (98) relates to said process, wherein in the mixture prepared according to (a), the weight ratio of catalyst relative to the one or more viscosity modifying and/or pore forming agents is in the range of from 10:1 to 30:1, preferably in the range of from 15:1 to 25:1, more preferably in the range of from 19:1 to 21:1.

A further preferred embodiment (100) concretizing any one of embodiments (93) to (99) relates to said process, wherein preparing the mixture in (a) comprises kneading, preferably in a kneader or in a mix-muller.

A further preferred embodiment (101) concretizing any one of embodiments (93) to (100) relates to said process, wherein in (b), shaping comprises extruding the mixture.

A further preferred embodiment (102) concretizing any one of embodiments (93) to (101) relates to said process, wherein in (b), the mixture is shaped to a strand, preferably to a strand having a circular cross-section.

A further preferred embodiment (103) concretizing embodiment (102) relates to said process, wherein the strand having a circular cross-section has a diameter in the range of from 0.2 to 10 mm, preferably in the range of from 0.5 to 5 mm, more preferably in the range of from 1 to 3 mm, more preferably in the range of from 1.5 to 2.5 mm, more preferably in the range of from 1.9 to 2.1 mm.

A further preferred embodiment (104) concretizing any one of embodiments (93) to (103) relates to said process, wherein shaping according to (b) further comprises drying the precursor of the molding in a gas atmosphere.

A further preferred embodiment (105) concretizing embodiment (104) relates to said process, wherein drying is carried out at a temperature of the gas atmosphere in the range of from 80 to 160° C., preferably in the range of from 100 to 140° C., more preferably in the range of from 110 to 130° C.

A further preferred embodiment (106) concretizing embodiment (104) to (105) relates to said process, wherein the gas atmosphere comprises nitrogen, oxygen, or a mixture thereof, wherein the gas atmosphere is preferably oxygen, air, or lean air.

A further preferred embodiment (107) concretizing any one of embodiments (93) to (106) relates to said process, wherein calcining in (c) is carried out at a temperature of the gas atmosphere in the range of from 400 to 600° C., preferably in the range of from 450 to 550° C., more preferably in the range of from 490 to 510° C.

A further preferred embodiment (108) concretizing any one of embodiments (93) to (107) relates to said process, wherein the gas atmosphere in (c) comprises nitrogen, oxygen, or a mixture thereof, wherein the gas atmosphere is preferably oxygen, air or lean air.

An embodiment (109) of the present invention relates to a process for the oxidation of hydrogen chloride to chlorine comprising
(A) providing a reactor comprising a reaction zone which comprises the catalyst according to any one of embodiments (1) to (33) or the molding of any one of embodiments (34) to (54);
(B) passing a reactant gas stream into the reaction zone obtained from (A), wherein the reactant gas stream passed into the reaction zone comprises hydrogen chloride, and oxygen; subjecting said reactant gas stream to reaction conditions in said reaction zone; and removing a product stream from said reaction zone, said product stream comprising chlorine.

A preferred embodiment (110) concretizing embodiment (109) relates to said a process, wherein in (A) the catalyst according to any one of embodiments (1) to (33) or the molding of any one of embodiments (34) to (54) is present in a fixed-bed and/or in a fluidized bed, preferably in a fixed-bed.

A further preferred embodiment (111) concretizing embodiment (109) or (110) relates to said process, wherein in (B) the reaction conditions comprise a temperature in the range of from 300 to 500° C., preferably in the range of from 360 to 400° C., more preferably in the range of from 370 to 390° C.

A further preferred embodiment (112) concretizing any one of embodiments (109) to (111) relates to said process, wherein in (B) the reaction conditions comprise a pressure in the range of from 0.05 to 2 MPa, preferably in the range of from 0.1 to 1.5 MPa, more preferably in the range of from 0.15 to 1 MPa, more preferably in the range of from 0.2 to 0.8 MPa, more preferably in the range of from 0.25 to 0.6 MPa, more preferably in the range of from 0.3 to 0.5 MPa, more preferably in the range of from 0.35 to 0.45 MPa, more preferably in the range of from 0.3 to 0.4 MPa.

A further preferred embodiment (113) concretizing any one of embodiments (109) to (112) relates to said process, wherein in (B) the molar ratio of hydrogen chloride to oxygen, HCl : O₂, in the reactant gas stream is in the range of from 1:1 to 5:1, preferably in the range of from 1.7:1 to 2.3:1, more preferably in the range of from 1.9:1 to 2.1:1.

A further preferred embodiment (114) concretizing any one of embodiments (109) to (113) relates to said process, wherein in (B) the reactant gas stream is fed by a stream comprising hydrogen chloride having a gas hourly space velocity in the range of from 350 to 550 L/(kg*h), preferably in the range of from 420 to 480 L/(kg*h), more preferably in the range of from 440 to 460 L/(kg*h).

A further preferred embodiment (115) concretizing any one of embodiments (109) to (114) relates to said process, wherein in (B) the reactant gas stream contains from 0.1 to 2.0 wt.-%, preferably from 0.7 to 1.3 wt.-%, more preferably from 0.9 to 1.1 wt.-%, of H₂O, based on 100 wt.-% of the reactant gas stream.

A further preferred embodiment (116) concretizing any one of embodiments (109) to (115) relates to said process, wherein in (B) the reactant gas stream is fed by a stream comprising hydrogen chloride, wherein the hydrogen chloride is obtained from a reaction of one or more isoand/or diisocyanates with phosgene, preferably from a reaction of methylenediphenylisocyanate and/or toluenediisocyanate with phosgene.

### EXPERIMENTAL SECTION

The present invention is further illustrated by the following examples and reference examples.

### Reference Example 1: Determination of the Total Pore Volume

The total pore volume was determined according to ISO 15901-2:2006.

### Reference Example 2: Determination of the Micropore Volume

The micropore volume was determined according to ISO 15901-3:2007.

### Reference Example 3: Determination of the Adsorption Average Pore Width (4 V/A)

The adsorption average pore width (4 V/A) was determined according to ISO 15901-2:2006.

### Reference Example 4: Determination of the Desorption Average Pore Diameter (4 V/A)

The desorption average pore diameter (4 V/A) was determined according to was determined according to DIN 66134:1998-02.

### Example 1: Preparation of a Catalyst

100.0 g of a carrier with hierarchical open pore architecture prepared in accordance with WO 2004/103558 A1 were added to a solution of 21.85 g of copper nitrate trihydrate (Cu(NO₃)₂ * 3 H₂O), 8.85 g of cerium nitrate hexahydrate (Ce(NO₃)₃ * 6 H₂O), 8.4 g of samarium nitrate hexahydrate (Sm(NO₃)₃ * 6 H₂O) and 8.95 g of potassium hydrate (KNO₃) dissolved in 200 ml of distilled water. The mixture was stirred at 82° C. for 30 min, and then cooled to 60° C. At that temperature, the mixture was evaporated to dryness. The resulting solid residue was further dried at 110° C. overnight and subsequently calcined at 500° C. for 5 h to obtain 108.5 g of a powder. The BET surface area of the obtained powder was determined to be 344 m²/g.

The carrier with hierarchical open pore architecture used as starting material had a crystallinity of 79%, an Al content of 16.6 wt.-%, an Fe content of 0.42 wt.-%, a La content of 4.3 wt.-%, a Si content of 23.2 wt.-%, and a Ti content of 0.86 wt.-%. The BET surface area was 443 m²/g, the Hg-porosity was 0.61 mL/g, and the carrier displayed an NH₃-TPD having peaks with corresponding concentrations of acid sites (Tₘₐₓ / mmol/g) of 203° C. / 0.890 mmol/g, 321° C. / 0.841 mmol/g, and 588° C. / 0.041 mmol/g.

### Example 2: Preparation of a Molding Comprising a Catalyst

100.0 g of a powder of the catalyst prepared according to Example 1 were mixed with 62.5 g of colloidal silica (Ludox AS-40) and 5.0 g Walocel binder (Wolf Walsrode AG PUFAS Werk KG), wherein the resulting mixture was kneaded for 10 min, after which 20.0 ml of distilled water were added and the resulting mixture was kneaded for an additional 20 min. The kneaded mixture was than extruded to strands with a diameter of 2.0 mm. The extrudate was then heated to 120° C. at a rate of 3° C./min, held at that temperature for 5 hours, and then heated further to 500° C. at a rate of 2° C./min and calcined at that temperature for 5 h for obtaining 89.7 g of the calcined extrudate. The extruded material was filtered for obtaining a split fraction in the range of from 0.3 to 0.5 mm, which was then filed into the reactor. The BET surface area was determined to be 289 m²/g.

The resulting molding had an Al content of 10.5 wt.-%, a Si content of 25.2 wt.-%, a Cu content of 4.2 wt.-%, a Ce content of 2.0 wt.-%, a Sm content of 2.0 wt.-%, a La content of 3.1 wt.-%, and a K content of 2.7 wt.-%. The BET surface area of the resulting molding was 289 m²/g, the total pore volume was 0.295 cm³/g, the micropore volume was 0.10 cm³/g, the adsorption average pore width (4 V/A) was 4.08, and the desorption average pore diameter (4 V/A) was 9.78 nm. The H₂-TPR data of the molding of Example 2 is shown in FIG. 2.

### Example 3: Catalytic Testing

The extrudates according to Example 2 were tested at 370° C. and metals composition were analyzed before and after 100 h stable operation. Elemental analysis shows 9.2 wt% Cl in the spent catalyst which means all other elements are reduced around 9% but keeping the molar concentration constant which is an indication that there is not a quick loss of Cu. For this reason, a new fresh sample of extrudates according to Example 2 was selected for the long stability tests (1000 h / 380° C., 1.4 NL/h HCl, 0.52 NL/h N₂, 0.7 NL/h O₂), the results of which are shown in FIG. 1, together with the results of the initial tests (370° C., 2.8 NL/h HCl, 1.04 NL/h N₂, 1.4 NL/h O₂). Thus, as it may be taken from the results displayed in FIG. 1, the catalyst according to the present invention displays not only a high yield in chlorine gas, but furthermore and more importantly displays a highly unexpected stability when employed over prolonged periods of time.

The extrudates were further evaluated under different conditions to study the influence of molar ratio HCl : O₂ and space velocity. Testing of the extrudates according to Example 2 under six different conditions and the resulting yields in chlorine are displayed in the following table:

| | Temperature [°C] | HCl [NL/h] | O₂ [NL/h] | Pressure [bar] | Cl₂ yield [%] |
|---|---|---|---|---|---|
| 1 | 370 | 2.8 | 1.4 | 3 | 20 |
| 2 | 380 | 1.4 | 0.7 | 3 | 36 |
| 3 | 380 | 1.4 | 1.4 | 3 | 51 |
| 4 | 380 | 1.4 | 2.8 | 3 | 61 |
| 5 | 400 | 1.4 | 2.8 | 3 | 84 |
| 6 | 420 | 1.4 | 2.8 | 3 | 92 |

The results indicate that O₂ adsorption is probably the rate-controlling step. In addition, higher partial pressure of O₂ would appear to prevent a deactivation of the active metal through bulk chlorination.

### DESCRIPTION OF THE FIGURES

FIG. 1 Results of long-stability test of the catalyst of Example 2 in the fixed-bed reactor according to Example 3 at 380° C. (1000 h, 1.4 NL/h HCl, 0.52 NL/h N₂, 0.7 NL/h O₂), including the results of the initial test conducted at 370° under different conditions (2.8 NL/h HCl, 1.04 NL/h N₂, 1.4 NL/h O₂).

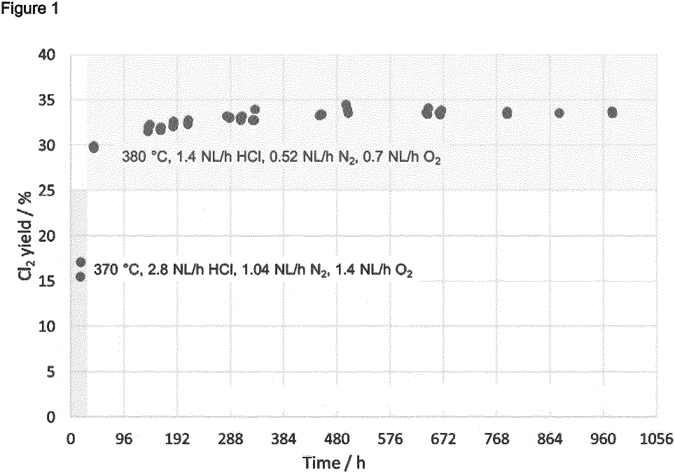

FIG. 2 H₂-TPR data of the molding of Example 2.

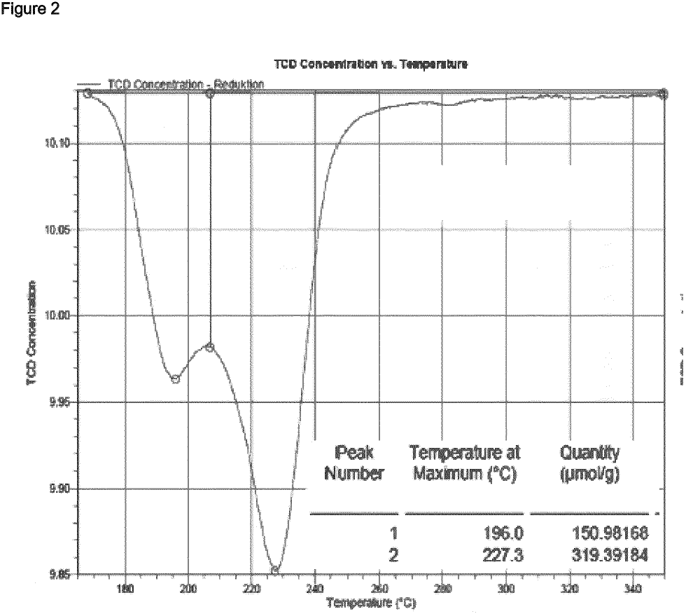

### CITED LITERATURE

US 4,493,902 A
US 5,023,220 A
US 5,395,809 A
US 5,559,067 A
WO 2004/103558 A1
WO 2017/218879 A1
WO 95/12454 A1
EP 2418016 A1
JP 2010248062 A
WO 2011/118386
EP 3549907 A1
EP 2481478 A1
CN 108097232 A
EP 3450014 A1
EP 3097976 A1
CN 106517095

1-15. (canceled)

16. A catalyst for the oxidation of hydrogen chloride to chlorine, wherein the catalyst comprises an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the inorganic carrier matrix and the zeolite are loaded with copper and with samarium, and wherein the zeolite is supported within the inorganic carrier matrix.

17. The catalyst of claim 16, wherein the inorganic carrier matrix is in the form of microsphere particles having a weight average particle diameter D50 comprised in the range of from 20 to 250 µm, wherein the weight average particle diameter D50 is determined according to ISO 13317-3:2001 and calculated according to ISO 9276-2:2014.

18. The catalyst of claim 16, wherein the inorganic carrier matrix displays an Hg-porosity in the range of from 0.1 to 2.5 mL/g, wherein the Hg-porosity is determined according to ISO 15901-1:2016.

19. The catalyst of claim 16, wherein the ammonia temperature programmed desorption of the inorganic carrier matrix displays:
a first peak in the range of from 150 to 270° C.; and
a second peak in the range of from 270 to 375° C.;
wherein the integration of the first peak offers a concentration of acid sites in the range of from 0.3 to 1.5 mmol/g; and
wherein the integration of the second peak offers a concentration of acid sites in the range of from 0.3 to 1.5 mmol/g.

20. The catalyst of claim 16, wherein the catalyst displays a molar ratio Y comprised in the inorganic carrier matrix and the zeolite to X comprised in the inorganic carrier matrix and the zeolite, calculated as YO₂: X₂O₃, in the range of from 0.5:1 to 10:1.

21. The catalyst of claim 16, wherein the zeolite has a framework structure type selected from the group consisting of FAU, GIS, MOR, LTA, FER, TON, MTT, BEA, MEL, MWW, MFS, MFI, and a mixed type of two or more thereof.

22. A molding comprising the catalyst according to claim 16.

23. The molding of claim 22, wherein the molding displays a BET surface area which is comprised in the range of from 50 to 600 m²/g, wherein the BET surface area is determined according to ISO 9277:2010.

24. The molding of claim 22, wherein the molding displays a total pore volume comprised in the range of from 0.2 to 0.4 cm³/g, wherein the total pore volume is determined according to ISO 15901-2:2006.

25. The molding of claim 22, wherein the copper loading of the molding is in the range of from 2 to 10 wt.-%, calculated as the element and based on 100 wt.-% of the total amount of Y and X, calculated as the respective oxides YO₂ and X₂O₃, contained in the molding.

26. The molding of claim 22, wherein the rare earth metal loading of the molding is in the range of from 5 to 15 wt.-% wt.-%, calculated as the element(s) and based on 100 wt.-% of the total amount of Y and X, calculated as the respective oxides YO₂ and X₂O₃, contained in the molding.

27. The molding of claim 22, wherein the hydrogen temperature programmed reduction of the molding displays:
a first peak in the range of from 175 to 225° C.; and
a second peak in the range of from 175 to 275° C.; and
wherein the integration of the first peak offers a concentration of reducible sites in the range of from 50 to 250 µmol/g; and
wherein the integration of the second peak offers a concentration of reducible sites in the range of from 225 to 600 µmol/g.

28. A process for the production of a catalyst for the oxidation of hydrogen chloride to chlorine according to claim 16, the process comprising
(i) providing a carrier comprising an inorganic carrier matrix and a zeolite, wherein the inorganic carrier matrix comprises Y, O, and optionally comprises X, wherein the zeolite comprises Y and O in its framework structure, and optionally comprises X in its framework structure, wherein Y is a tetravalent element and X is a trivalent element, wherein the zeolite is supported within the inorganic carrier matrix;
(ii) subjecting the carrier to one or more ion-exchange procedures with copper, further with samarium, obtaining a precursor of the catalyst;
(iii) calcining the precursor of the catalyst in a gas atmosphere, obtaining the catalyst.

29. A process for production of a molding comprising a catalyst, the process comprising
(a) preparing a mixture comprising water, a binder or a precursor thereof and a catalyst according to claim 16;
(b) shaping the mixture obtained from (a), obtaining a precursor of the molding;
(c) calcining the precursor of the molding in a gas atmosphere, obtaining the molding.

30. A process for the oxidation of hydrogen chloride to chlorine comprising
(A) providing a reactor comprising a reaction zone which comprises the catalyst according to claim 16;
(B) passing a reactant gas stream into the reaction zone obtained from (A), wherein the reactant gas stream passed into the reaction zone comprises hydrogen chloride, and oxygen; subjecting said reactant gas stream to reaction conditions in said reaction zone; and removing a product stream from said reaction zone, said product stream comprising chlorine.
